(19) United States
(12) Patent Application Publication
(10) Pub. No.: US 2026/0279820 A1
(43) Pub. Date: Sep. 17, 2026

(54) SINGLE-PARTICLE LAYER-CONTAINING ELECTRODE AND METHOD OF MAKING AND USING THE SAME

(71) Applicant: Battelle Memorial Institute, Richland, WA (US)

(72) Inventors: Dongping Lu, Richland, WA (US); Shuo Feng, Tarrytown, NY (US); Jie Xiao, Richland, WA (US)

(73) Assignee: Battelle Memorial Institute, Richland, WA (US)

(21) Appl. No.: 19/162,296

(22) PCT Filed: Mar. 12, 2024
(86) PCT No.: PCT/US2024/019509

§ 371 Date: Sep. 4, 2025

Related U.S. Application Data
(60) Provisional application No. 63/452,064, filed on Mar. 14, 2023.

(51) Int. Cl. H01M 4/62; H01M 4/02; H01M 4/04; H01M 4/48

(52) U.S. Cl. CPC H01M 4/625; H01M 4/0404; H01M 4/0435; H01M 4/48; H01M 2004/021; H01M 2004/027; H01M 2004/028

(57) ABSTRACT

Disclosed herein is an electrode comprising a single-particle layer that exhibits both low porosity and low tortuosity. In the single-particle layer, a plurality of secondary particles is aligned horizontally along the deposition surface of a substrate upon which the single-particle layer is deposited and no more than one particle is positioned vertically along the deposition surface. Devices comprising the electrode also are disclosed along with methods for making and using the single-particle layer-containing electrode.

### CROSS REFERENCE TO RELATED APPLICATION

This application claims the benefit of and priority to U.S. Provisional Patent Application No. 63/452,064, filed on Mar. 14, 2023, the entirety of which is incorporated herein by reference.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

The present disclosure is directed to a single-particle layer-containing electrode that exhibits both low porosity and low tortuosity, along with methods of making and using the same.

### BACKGROUND

Cathode porosity should be reduced as much as feasible to balance the electrolyte distribution in electrochemical cells, particularly lithium-sulfur (Li—S) cells, thereby conserving more pore-filling electrolyte to extend cell cycle life; however, low-porosity electrodes built with nanosized electroactive materials can suffer from high tortuosity that significantly deteriorates electrode wetting and electroactive material utilization. This is particularly true for sulfur/carbon (“S/C”) materials. Enabling operation of electrodes having high-loadings of the electrochemical material under both low-porosity and lean-electrolyte conditions is still a challenge and is seldom discussed in the art. There exists a need in the art for new methods to reduce the tortuosity of dense electrodes at the same time as minimizing porosity to thereby facilitate electrodes that conserve electrolyte usage but exhibit suitable electroactive material usage.

### SUMMARY

Disclosed herein is an electrode according to aspects of the present disclosure, comprising: a substrate having a deposition surface; and a single layer of secondary particles deposited on the deposition surface of the substrate such that each secondary particle of the single layer is positioned horizontally along the deposition surface and no more than one secondary particle is deposited vertically along the deposition surface; wherein each secondary particle of the single layer has an average particle size of at least 40 μm and comprises an electroactive material comprising sulfur.

Also disclosed is an electrode according to aspects of the present disclosure, comprising: a substrate having a deposition surface; and a single layer of secondary particles deposited on the deposition surface of the substrate such that each secondary particle of the single layer is positioned horizontally along the deposition surface and no more than one secondary particle is deposited vertically along the deposition surface; wherein each secondary particle of the single layer has an average particle size ranging from 0.1 nm to 500 μm and comprises an electroactive material other than sulfur.

Also disclosed is a method of making the electrode according to aspects of the present disclosure, comprising: casting a slurry of the secondary particles onto the deposition surface of the substrate while controlling a thickness of the slurry during casting to be no greater than 200% of the average particle size of each secondary particle and such that only one secondary particle is deposited vertically along the deposition surface. In any or all aspects, the method can further comprise: (i) mixing a binder, a conductive material, or a combination thereof with the secondary particles to form the slurry; (ii) drying the electrode; (iii) calendaring the electrode; or (iv) a combination of two or more of (i), (ii), and (iii).

Also disclosed is a cell according to aspects of the present disclosure, comprising: the single-layer electrode according to aspects of the present disclosure; a second electrode; and an electrolyte.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 provides schematics of (i) an electrode comprising a plurality of particles that are randomly dispersed on the deposition surface of a substrate such that a multiple-particle layer (also referred to herein as “MPL”) electrode structure is obtained wherein multiple particles are deposited vertically and horizontally along the substrate surface (top image) and (ii) an electrode comprising a plurality of secondary particles that are deposited along the substrate surface such that only one particle is deposited vertically along the deposition surface of a substrate thus providing a single-particle layer-containing (also referred to herein as “SPL”) electrode according to the present disclosure (bottom image).

FIGS. 2A and 2B are micro-computed tomography (micro-CT) images showing morphologies of an MPL-containing electrode obtained using small particles (FIG. 2A) and an SPL-containing electrode obtained using exemplary secondary particles disclosed herein (FIG. 2B).

FIGS. 3A and 3B are illustrations of simulations and design principles of a cathode comprising small sulfur/carbon (or “S/C”) particles (e.g., average particle size of less than 20 μm) and a cathode comprising large particles S/C particles (e.g., average particle size of greater than 90 m) at an initial state and a steady state of electrolyte infiltration (FIG. 3A), as well as at an intermediate state and steady state of lithium polysulfides (also referred to herein as “LiPS”) migration in the two cathodes (FIG. 3B).

FIGS. 4A and 4B are graphs showing correlations between a cathode's porosity and its volumetric capacity (FIG. 4A) and gravimetric capacity (FIG. 4B) at various electrode porosities.

FIGS. 5A and 5B are graphs showing electrolyte distribution in a Li—S cell under flooded (FIG. 5A) and lean (FIG. 5B) electrolyte conditions at various electrode porosities.

FIGS. 6A and 6B are graphs of simulation results showing surface wetting degree (FIG. 6A) and electrolyte absorption degree (FIG. 6B) in electrodes comprising small particles or large particles at steady state.

FIG. 7 is a schematic simulating the initial state of polysulfides migration in large and small particles.

FIGS. 8A-8C are graphs showing LiPS normalized diffusivity at different depths of an SPL-containing electrode and an MPL-containing electrode at steady state (FIG. 8A); time of LiPS diffusing out of the electrode at different depts of an SPL-containing electrode and an MPL-containing electrode (FIG. 8B); and LiPS concentration at different depths of electrodes comprising either small or large particles at steady state (FIG. 8C).

FIGS. 9A and 9B are SEM and micro-CT images of an MPL-containing electrode comprising S/C particles (FIG. 9A, SEM=left-most image; micro-CT=right-most image) and an SPL-containing electrode comprising S/C particles (FIG. 9B, SEM=left-most image; micro-CT=right-most image).

FIGS. 10A-10D are SEM images of small secondary IKB/S particles (FIGS. 10A and 10B) and large IKB/S particles secondary particles (FIGS. 10C and 10D).

FIGS. 11A and 11B are graphs showing BET adsorption-desorption measurements of small and large IKB secondary particles before and after sulfur infusion (FIG. 11A); and pore size distribution of small and large IKB secondary particles (FIG. 11B).

FIGS. 12A-12D are SEM images of an MPL-containing electrode comprising S/C particles (FIG. 12A) and a SPL-containing electrode comprising S/C particles (FIG. 12C) before calendaring and the electrodes after calendaring to provide electrodes exhibiting 45% porosity (FIG. 12B=MPL-containing electrode; and FIG. 12D=SPL-containing electrode).

FIGS. 13A-13C are graphs showing electrochemical cycling performances of the MPL- and SPL-containing electrodes under flooded electrolyte conditions (E/S ratio=10 μL mg s⁻¹) at 0.1 C (1 C=1000 mA g⁻¹) at different levels of electrode porosity (FIG. 13A=62% porosity; FIG. 13B=53% porosity; FIG. 13C=45% porosity).

FIGS. 14A-14C are graphs showing discharge and charge curves of SPL- and MPL-containing electrode under flooded electrolyte conditions at 0.1 C, at 62% electrode porosity (FIG. 14A), 53% electrode porosity (FIG. 14B), and 45% electrode porosity (FIG. 14C).

FIG. 15 is a graph showing typical discharge and charge curves of the MPL- and SPL-containing electrodes at 1 C.

FIGS. 16A-16C are graphs showing discharge and charge curves of SPL- and MPL-containing electrodes under lean electrolyte condition at 62% electrode porosity (FIG. 16A), 53% electrode porosity (FIG. 16B), and 45% electrode porosity (FIG. 16C).

FIGS. 17A-17C are graphs showing electrochemical cycling performances of the MPL- and SPL-containing electrodes under lean electrolyte conditions (E/S ratio=4 μL mg s⁻¹) at 0.1 C (1 C=1000 mA g⁻¹) at different levels of electrode porosity (FIG. 17A=62% porosity; FIG. 17B=53% porosity; FIG. 17C=45% porosity).

FIGS. 18A-18D show results obtained using energy dispersive spectroscopy (EDS) (FIGS. 18A and 18C) and electrochemical impedance spectroscopy (EIS) (FIGS. 18B and 18D) to evaluate an MPL-containing electrode and an SPL-containing electrode with 45% electrode porosity after electrolyte infiltration during cell rest, collected every 30 minutes.

FIGS. 19A and 19B are electron dispersive x-ray spectroscopy images of an MPL-containing electrode (FIG. 19A) and SPL-containing electrode (FIG. 19B) after contacting the electrodes with 1M LiTFSI/DOL/DME.

FIGS. 20A and 20B are graphs showing volumetric capacity of MPL-containing electrode and SPL-containing electrode under flooded and lean electrolyte conditions at each porosity (FIG. 20A) and comprehensive specific capacity (“CSC”) of MPL-containing electrode and SPL-containing electrode under flooded and lean electrolyte conditions at each porosity (FIG. 20B).

FIGS. 21A and 21B show results from using ex situ synchrotron XRD to characterize an SPL-containing electrode at different depths of discharge, wherein FIG. 21A shows the first cycle discharge/charge curves and FIG. 21B shows the corresponding XRD patterns (λ=0.19316) for the SPL-containing electrode (wherein successive diffraction patterns are vertically offset by 6,000 relative to that of the pristine cathode (point 0, no offset)).

FIGS. 22A and 22B show results from using ex situ synchrotron XRD to characterize an MPL-containing electrode at different depths of discharge, wherein FIG. 22A shows the first cycle discharge/charge curves and FIG. 22B shows the corresponding XRD patterns (λ=0.19316) for the MPL-containing electrode (wherein successive diffraction patterns are vertically offset by 6,000 relative to that of the pristine cathode (point 0, no offset)).

FIGS. 23A-23D shows characterizations of the SPL/MPL-containing electrode and the corresponding lithium anodes after first discharge under lean-electrolyte conditions (SPL=FIG. 23A and MPL-containing electrode=FIG. 23C), along with the corresponding in situ EIS of the SPL-containing electrode (FIG. 23B) and MPL-containing electrode (FIG. 23D).

FIGS. 24A and 24B are illustrations depicting mechanistic differences in the reaction process for an SPL-containing electrode and an MPL-containing electrode.

FIGS. 25A-25H include SEM images of the SPL-containing electrode (FIGS. 25A and 25B) and MPL-containing electrode (FIGS. 25E and 25F) and images obtained from EDS analysis of the anodes in the SPL-containing electrode (FIGS. 25C and 25D) and MPL-containing electrode (FIGS. 25G and 25H), wherein the inset pictures in FIGS. 25C and 25G are digital images of lithium chips after the first discharge.

FIG. 26 shows high magnification of an SEM image of Li₂S on the MPL-containing electrode.

### DETAILED DESCRIPTION

### Overview of Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects of the disclosure from discussed prior art, the numbers are not approximates unless the word “about” is recited.

Although the operations of some of the aspects of the disclosure are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by one of ordinary skill in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to the illustrated aspects of the disclosure. Such terms are not, however, intended to imply absolute relationships, positions, and/or orientations. For example, with respect to an object, an “upper” part can become a “lower” part simply by turning the object over. Nevertheless, it is still the same part and the object remains the same.

In order to facilitate review of the various aspects of the disclosure, the following explanations of specific terms are provided:

Average Particle Size: A mathematical average diameter of a plurality of particles, wherein diameters of individual particles are considered in arriving at the average. Particle diameter may be determined by any suitable method including, but not limited to, scanning electron microscopy.

Average Channel Width: A mathematical average width of a plurality of channels, wherein widths of individual channels are considered in arriving at the average.

Binder: A component that is used to bind secondary particles together through chemical binding between functional groups of the binder (e.g., —OH, —OOH, or anions thereof) and the secondary particles. Binders, as described herein, are separate and distinct from a conductive carbon material that is used to join nanoparticles into aggregates that form the secondary particles.

Capacity: The capacity of a cell is the amount of electrical charge a cell can deliver. The capacity is typically expressed in units of mAh, or Ah, and indicates the maximum constant current a cell can produce over a period of one hour. For example, a cell with a capacity of 100 mAh can deliver a current of 100 mA for one hour or a current of 5 mA for 20 hours.

Calendaring: A process whereby a substrate coated with a single-particle layer of secondary particles is compressed to a desired final dimension.

Cell: As used herein, a cell refers to an energy storage device used for generating a voltage or current from a chemical reaction, or the reverse in which a chemical reaction is induced by a current. Examples include voltaic cells, electrolytic cells, and fuel cells, among others. A battery typically includes one or more cells.

Channel: In single-particle layer electrodes of the present disclosure, a channel is formed between individual secondary particles by way of depositing the secondary particles on a deposition surface of a substrate according to the method described herein. A channel typically is a void or space that exists between outer surfaces of the secondary particle such that an electrolyte can pass through the channel.

Channel Width: A measurement of the width of a void or space making up a channel of a single-particle layer electrode according to the present disclosure that typically is measured from an outer surface of a first secondary particle to an outer surface of an adjacent second secondary particle.

Conductive Carbon Material: This term refers to an electrode component that provides additional electronic conductivity to enable electrochemical reactions of the electrode. In some aspects of the disclosure, the conductive carbon material includes, but is not limited to, amorphous carbon, carbon black, carbon nanofiber (CNF), carbon nanotube (CNT), graphene, reduced graphene oxide, carbon products formed from decomposing organic precursors, and combinations thereof.

Electroactive Material: A material (e.g., an element, an ion, an organic compound, or an inorganic compound) that is capable of forming redox pairs having different oxidation and reduction states (e.g., ionic species with differing oxidation states or a metal cation and its corresponding neutral metal atom). Conversions between chemical energy and electricity energy occur with an accompanying change in oxidation state these ions or compounds. In a flow battery, an electroactive material refers to the chemical species dissolved in certain solutions that participate(s) in the redox reaction during the charge and discharge processes, significantly contributing to the energy conversions that ultimately enable the battery to deliver/store energy. By “significantly contributing” is meant that a redox pair including the electroactive material contributes at least 10% of the energy conversions that ultimately enable the battery to deliver/store energy. In some aspects of the disclosure, the redox pair including the electroactive material contributes at least 50%, at least 75%, at least 90%, or at least 95% of the energy conversions of a cell comprising the electroactive material in a catholyte or anolyte.

Electrode Porosity: A measurement of the porosity exhibited by a layer of secondary particles formed on an assembled electrode.

Electrode Tortuosity: A measurement of the tortuosity exhibited by a layer of secondary particles formed on an assembled electrode.

Multiple-Particle Layer: A layer formed on a deposition surface of a substrate that comprises a plurality of particles wherein the particles are randomly dispersed along the deposition surface such that two or more particles are arranged both horizontally and vertically along the deposition surface. In a multiple-particle layer, a majority of the surface area of the multiple-particle layer comprises the horizontally- and vertically-arranged particles, such as more than 50% of the surface area.

Particle Porosity: A measurement of the internal porosity of a particle, such as a secondary particle described herein.

Particle Tortuosity: A measurement of the internal tortuosity of a particle, such as a secondary particle described herein.

Secondary Particle: A particle comprising an aggregation of nanoparticles, wherein the nanoparticles are joined together through a conductive carbon material. In particular disclosed aspects of the disclosure, the nanoparticles are first chemically (e.g., covalently) cross-linked together through an organic precursor (e.g., citric acid, ethylene glycol, and other precursors described herein). After a heating step, a conductive carbon framework is formed from the organic precursor, which covers and interconnects the cross-linked nanoparticles to form secondary particles.

Single-Particle Layer: A layer formed on a deposition surface of a substrate that comprises a plurality of secondary particles wherein no more than one secondary particle is arranged vertically along the deposition surface and wherein two or more of the secondary particles are arranged horizontally along the deposition surface. In some independent aspects of the disclosure, a small portion (e.g., less than 50% of the surface area of the single-particle layer, such as less than 40%, or less than 30%, or less than 20%, or less than 10% of the surface area of the single-particle layer) of the single-particle layer may comprise a single secondary particle arranged vertically along the deposition surface that exhibits cracking or distortion caused by calendaring and thus the fragments of the secondary particle may appear to be stacked vertically; however, such aspects are not equivalent to a multiple-particle layer wherein a plurality of particles are stacked vertically. Such aspects are recognizable to those skilled in the art using an imaging technique like SEM, particularly with the benefit of the present disclosure.

Substrate: A material upon which secondary particles according to the present disclosure are deposited. A substrate typically has a deposition surface upon which the secondary particles are deposited. The substrate can comprise a material that is suitable for use in an electrode, such as in an anode or a cathode (or both). Suitable substrate materials are described herein.

Specific capacity: A term that refers to capacity per unit of mass. Specific capacity may be expressed in units of mAh/g.

### Introduction

Electrodes with both low porosity and low tortuosity are expected to have improved performance relative to conventional electrodes; however, current methods for making electrodes do not provide an avenue for achieving both low porosity and low tortuosity in the same electrode. In particular, electrodes typically have either low tortuosity and high porosity, or low porosity and high tortuosity. The inability to achieve both properties in the same electrode is a problem that has not been solved in the art.

The above-mentioned problem is a particular issue for lithium-sulfur (Li—S) batteries and electrodes used in such systems. Li—S batteries feature a high theoretical energy (~2300 Wh kg-1) and a very low cost, making such batteries one of the most cost-effective ($/kWh) battery technologies for vehicle electrification and grid energy storage. Development of a high-performance Li—S battery is plagued by the low electronic/ionic conductivities of sulfur and Li₂S, dissolution of lithium polysulfides (also referred to herein as “LiPS”), electrolyte consumption, and Li corrosion. To address these barriers, different strategies have been adopted in the art, such as anchoring soluble LiPS generated during the electrochemical process to improve the associated cell cycling stability, including by using various carbon hosts, polymer backbones, or inorganic polar materials. However, promising performance is usually derived from cells with thin film electrodes and/or excessive amounts of electrolyte (electrolyte volume to sulfur weight ratio, e.g., E/S ratio>10 μL mg⁻¹), which are not transferable to practical Li—S batteries. Efforts have been made to either improve sulfur loading in cathodes or reduce the electrolyte amount by developing polar materials or modifying material surfaces; however, sulfur cathode porosity, which is as high as 70%, is a parameter that has not been investigated. In the case of sulfur-containing cathodes, the cathode typically is occupied by a large fraction of voids or pores that cause low cell-level energy density and a short cycle life. To realize a long cycle life of Li—S cells under lean-electrolyte conditions (e.g., E/S<4), the cathode porosity needs to be minimized; otherwise, most of the electrolyte will be trapped in the porous cathode, leaving only a small portion of electrolyte available to support cell cycling and compensate for the inevitable electrolyte consumption that occurs during lithium plating/stripping.

Reducing cathode porosity, however, usually results in a highly tortuous electrode, for which electrode wetting becomes a significant challenge. Particularly in a Li—S cell based on sulfur dissolution-deposition reactions, lack of electrode wetting leads to both poor sulfur conversion kinetics and a low utilization rate. Attempts to build low tortuosity electrode architectures have focused on using magnetic templates, freeze drying, laser patterning, or vertically-aligned-graphene based free standing electrodes. And, while electrodes comprising “open-throat” pores might form a low-tortuosity structure and provide highways for electrolyte transport in the electrodes, this typically results in a highly porous electrode, which lowers cell level energy density significantly. In addition, the complicated electrode processing or removal of the pore-forming templates decreases the feasibility of these approaches in practical applications. In the case of Li—S batteries, such systems involve LiPS dissolution and diffusion (or “LiPS shuttling”), thus an electrode structure with evenly distributed low tortuosity is likely to accelerate the LiPS outflow and loss, contributing the problems associated with such systems. For example, when reducing the electrode porosity in sulfur electrodes composed of nanocarbon materials, the loosely packed nanoparticles will intimately contact each other and form a high-tortuosity electrode with narrower or even disconnected channels. This will reduce the electrode's accessibility to electrolyte (especially under lean-electrolyte conditions) and lead to at least two more consequences: (1) only sulfur at the surface can quickly access electrolyte to participate in redox reactions, and (2) the generated Li₂S and Li₂S₂ preferentially deposit on the electrode surface regions, blocking the electrode surface and accelerating irreversible capacity loss. Therefore, particular challenges for low-porosity electrodes, particularly low-porosity sulfur electrodes can include (1) the poor electrolyte accessibility caused by the highly tortuous electrode structure, (2) the exacerbated shuttling effect due to the increased LIPS concentration gradient, and (3) the early electrode surface passivation caused by Li₂S deposition. The above-mentioned drawbacks are not limited solely to Li—S batteries and can exist in battery systems comprising electrodes with other types of electroactive material, particularly porous materials.

Disclosed herein is a single-particle layer-containing electrode that exhibits both low porosity and low tortuosity and methods of making the same. In some aspects of the disclosure, the single-particle layer-containing electrode exhibits a low porosity of lower than 60%, such as lower than 50%, or 45% or lower. Such electrodes further exhibit a lower tortuosity, with some aspects of the disclosure exhibiting a tortuosity lower than 2, such as lower than 1.8, or lower than 1.6, or lower than 1.4. The disclosed single-particle layer-containing electrode comprises aligned secondary particles that are positioned such that only a single-particle layer is formed. In the single-particle layer, each particle of the single layer is positioned horizontally along a deposition surface of a substrate and no more than one particle is deposited vertically along the deposition surface. Such electrodes comprise low-tortuosity through-pores that enhance electrolyte infiltration. Further, the high inside-tortuosity of large secondary particles helps suppress undesired shuttling that might otherwise take place. In particular aspects of the disclosure, when electrode porosity is reduced to as low as ~45%, electrode according to aspects of the present disclosure can still deliver a high discharge capacity, such as 4 mAh cm⁻² (or 1001 mAh g⁻¹) for an electrode with sulfur mass loading of 4 mg cm⁻², even at very low electrolyte-to-active material ratios (e.g., 4 μL mg⁻¹). The disclosed method of making the single-particle layer-containing electrode can be applied towards making electrodes with a variety of electroactive materials and can be used to make anodes and/or cathodes.

### Electrodes

Electrodes of the present disclosure comprise a single-particle layer (also referred to herein as “SPL”) that is formed by secondary particles of an electroactive material. The single-particle layer of the electrode is formed from the secondary particles such that the secondary particles are positioned horizontally along a deposition surface of a substrate and no more than one secondary particle is deposited vertically along the deposition surface. Electrodes used in the art typically comprise a layer of electroactive material that might constitute a “single” layer of the electroactive material; however, any electroactive material used in such electrodes that might be in particle form is typically present within the layer such that the particles are positioned randomly in vertical and/or horizontal directions on the substrate (e.g., as a dispersion) and not aligned in the same single-layer configuration as the presently disclosed secondary particles. For example, such electrodes typically comprise a layer of electroactive material wherein multiple particles are stacked both vertically and horizontally along any deposition surface of an electrode substrate resulting in a multiple-particle layer (also referred to herein as “MPL”). By providing the single-layer configuration of secondary particles as in the present disclosure, the thickness of the single layer of electroactive material can be controlled so as to have a single particle thickness, which thereby facilitates achieving low tortuosity and low porosity.

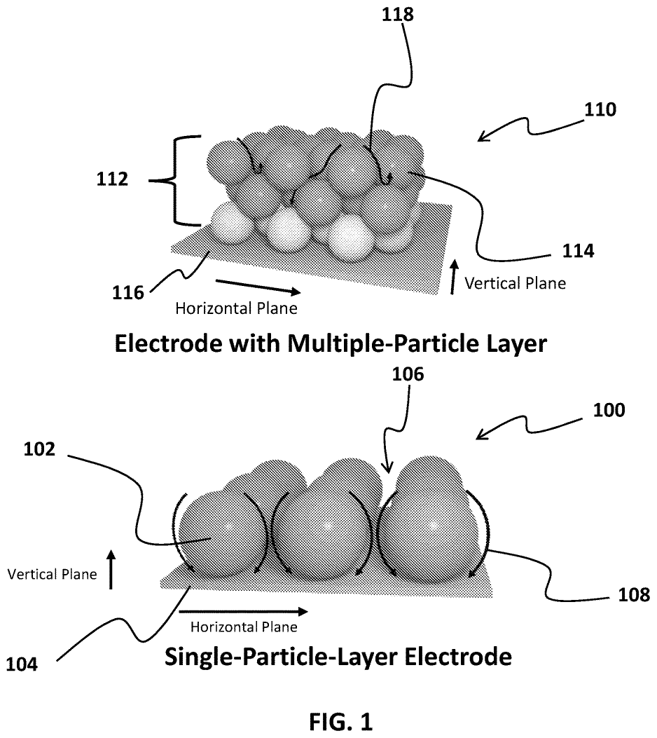

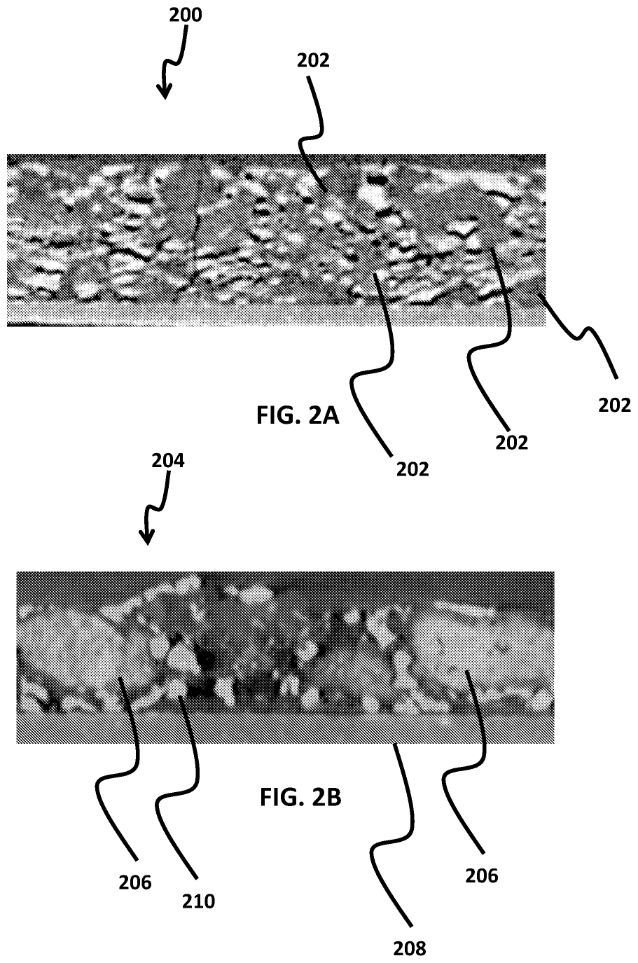

An exemplary image of a single-particle layer-containing electrode according to aspects of the present disclosure is illustrated in FIG. 1 (bottom image) and is further compared with an electrode that does not comprise a single-particle layer and instead comprises a multiple-particle layer (top image). As can be seen in FIG. 1, SPL-containing electrode 100 comprises a single layer of particles 102 deposited on a substrate 104, wherein no more than one particle is deposited vertically along the deposition surface of substrate (as illustrated in FIG. 1, no more than one particle is deposited along the vertical plane of the deposition surface of the substrate). The SPL provides channels 106 through which an electrolyte can flow with minimal tortuosity as represented by arrows 108. In contrast, while electrode 110 comprises a single layer of electroactive material 112, particles 114 that forms the single layer of material are dispersed randomly in the layer such that particles are positioned next to one another in both the vertical and horizontal directions relative to substrate 116 (as illustrated in FIG. 1, two or more particles are deposited along both the vertical and horizontal planes of the deposition surface of the substrate). This configuration results in a more tortuous path for the electrolyte as represented by arrows 118. A further comparison of an SPL-containing electrode and an MPL-containing electrode can be seen in comparing FIGS. 2A and 2B. FIG. 2A shows electrode 200 comprising particles 202 that are not arranged in a single-particle layer and instead form a multiple-particle layer. In the MPL-containing electrode, particles 200 are randomly dispersed throughout the MPL. In contrast, FIG. 2B shows an electrode wherein electrode 204 comprises a plurality of secondary particles 206 that are arranged in an SPL such that the secondary particles are only positioned horizontally along the surface of substrate 208; none of the secondary particles are arranged such that two or more particles are arranged vertically along the deposition surface of the substrate. The small masses shown in FIG. 2B (e.g., see small mass 210) are the binder and/or a carbon additive and are not secondary particles.

The electrodes of the present disclosure comprise secondary particles that can be made of precursor particle materials (e.g., carbon-containing, lithium-containing materials, and the like). The secondary particles comprise an aggregation of primary particles comprising the precursor particle material, wherein the primary particles have a smaller average particle size than the secondary particles. Aggregation of the primary particles typically is facilitated by using a conductive material (e.g., a conductive carbon material) capable of forming chemical bonds with the primary particles. Interconnecting the primary particles allows the aggregation of the primary particles into the larger secondary particles. In some aspects of the disclosure, the primary particles are substantially coated with the conductive carbon material. In some aspects of the disclosure, the secondary particles can further comprise a binder that can be used to facilitate positioning the secondary particles such that they are physically close to one another along the deposition surface of the substrate upon which they are deposited. The secondary particles can further comprise an additional electroactive material, which can be provided by adding a separate electroactive species into a mixture used to make the secondary particles. Exemplary secondary particles are described in U.S. Pat. No. 9,577,250, the relevant portion of which is incorporated herein by reference.

Exemplary additional electroactive materials for use in secondary particles according to the present disclosure can include, but are not limited to, sulfur-containing materials, phosphates, sulfides, sulfates, transition metal oxides, and combinations thereof. Exemplary electroactive materials for use in cathodes can include, but are not limited to, sulfur, lithium cobalt oxide (having a formula LiCoO₂, and also referred to as “LCO”), lithium nickel cobalt aluminum oxide (or “NCA”), lithium iron phosphate (or “LFP”), lithium nickel manganese cobalt oxide (having a formula LiNiₓMn_{y}Co_{z}O₂, wherein x+y+z=1, also referred to as “NMC”), lithium nickel manganese cobalt oxide (or “LNMO”), olivine LiFePO₄, lithium manganese oxide (or “LMO”), and LMFP materials having a formula LiMnₓFe₁₋ₓPO₄. Exemplary electroactive materials for use in anodes can include, but are not limited to, a metal material (e.g., lithium, sodium, potassium, tin, aluminum, magnesium, silver, antinomy, and any alloys thereof), a carbon-based material (e.g., graphite, graphene, carbon nanotubes or nanoparticles, and the like), a silicon-based material (e.g., silicon or silicon oxides), or combinations thereof.

Electrodes of the present disclosure exhibit controlled shuttling of ions and/or chemical compounds that might be produced during use. In particular aspects of the disclosure comprising sulfur-based electroactive materials, utilizing an SPL according to the present disclosure helps to control LIPS shuttling. For example, electrodes comprising a single-particle layer of a sulfur-based electroactive material exhibit a smaller proportion of LiPS diffusion relative to electrodes comprising randomly dispersed particles that form an MPL. Because less LIPS diffuses from the inventive electrodes, the particles retain a high polysulfide concentration within the particles and thus avoid problems associated with high LiPS shuttling and/or loss. As such, the SPL of electrodes according to the present disclosure facilitates making electrodes that exhibit improved performance, particularly for particles comprising electroactive materials that are prone to shuttling and/or diffusion from the particles.

In some aspects of the disclosure, secondary particles according to the present disclosure can have an average particle size ranging from 0.1 μm to 600 μm, such as 0.5 μm to 500 μm, or 1 μm to 500 μm, or 10 μm to 500 μm, 20 μm to 500 μm, or 40 μm to 500 μm, or 50 μm to 500 μm, or 100 μm to 500 μm, or 200 μm to 500 μm. In some aspects of the disclosure, the secondary particles have an average particle size that is greater than 50 μm or greater than 60 μm, or greater than 70 μm, or greater than 80 μm, or greater than 90 μm. In some particular aspects of the disclosure, the secondary particles have an average particle size greater than 20 μm, such as from 40 μm to 500 μm, or from 50 μm to 500 μm, or from 60 μm to 500 μm, or from 70 μm to 500 μm, or from 80 μm to 500 μm, or from 90 μm to 500 μm, or from 100 μm to 500 μm. In yet additional aspects of the disclosure, the secondary particles have an average particle size of at least 40 μm to 500 μm, such as 50 μm to 500 μm, or from 60 μm to 500 μm, or from 70 μm to 500 μm, or from 80 μm to 500 μm, or from 90 μm to 500 μm, or from 100 μm to 500 μm. In some such aspects of the disclosure, the secondary particles comprise an additional electroactive material that is a sulfur electroactive material. In particular aspects of the disclosure comprising sulfur-containing secondary particles, the secondary particles have an average particle size ranging from 40 μm to 100 μm (such as from 40 μm to 90 m), or from 90 μm to 200 μm (such as 100 μm to 200 μm), or from 200 μm to 500 μm. In other aspects of the disclosure, the secondary particles comprise an additional electroactive material other than sulfur, such as lithium cobalt oxide (or “LCO”), lithium nickel cobalt aluminum oxide (or “NCA”), lithium iron phosphate (or “LFP”), lithium nickel manganese cobalt oxide (or “NMC”), lithium nickel manganese cobalt oxide (or “LNMO”), lithium manganese oxide (or “LMO”) or combinations thereof. In some such aspects of the disclosure, the secondary particles can have an average particle size ranging from 0.1 μm to 500 μm, such as 0.5 μm to 500 μm, or 1 μm to 500 μm, or 10 μm to 500 μm, 20 μm to 500 μm.

In some aspects of the disclosure, the above-mentioned average particle sizes are exhibited by the secondary particles before any calendaring. In yet some other aspects of the disclosure, this average particle size is exhibited by the secondary particles after calendaring. In some aspects of the disclosure, the thickness of the single-particle layer of the electrodes disclosed herein can correspond to the average particle size of the secondary particles in view of the single-particle layer configuration included in the electrodes. In some aspects of the disclosure, the thickness of the electrode, including the substrate upon which the SPL is deposited, is no greater than 200% of the average particle size of the secondary particles, such as no greater than 150%, or 140%, or 130%, or 120%. In such aspects of the disclosure, the thickness of the electrode can further include (in addition to the thickness of the substrate and any secondary particles) the thickness of any binder and/or additive materials included in the SPL. In particular aspects of the disclosure, the thickness of the single-particle layer, excluding any substrate upon which layer is deposited, can range from greater than 40 μm, such as from 40 μm to 500 μm, or from 50 μm to 500 μm, or from 60 μm to 500 μm, or from 70 μm to 500 μm, or from 80 μm to 500 μm, or from 90 μm to 500 μm, or from 100 μm to 500 μm. In some aspects of the disclosure, the single-particle layer has a thickness that is greater than 50 μm or greater than 60 μm, or greater than 70 μm, or greater than 80 μm, or greater than 90 μm. In particular aspects of the disclosure, the single-particle layer has a thickness ranging from 40 μm to 90 μm, or from 100 μm to 200 μm, or from 200 μm to 500 μm.

Electrodes of the present disclosure further comprise a substrate upon which the secondary particles are deposited. Substrates used to make the electrode comprise a deposition surface upon which the secondary particles are deposited. The substrate can be made of any material suitable for use in an electrode, such as a metal-based material. In some aspects of the disclosure, the substrate can take any form suitable for use as an electrode, such as a current collector, a sandwich-type configuration, free-standing carbon nanofibers and/or nanotubes, and the like. In particular aspects of the disclosure, the substrate is a metal foil current collector, such as an aluminum foil or other such material.

Channels can be created between the particles of the single-particle layer upon deposition of the particles on the substrate. In particular aspects of the disclosure, the channels are provided as void space between the outer perimeter of the different particles making up the single-particle layer. The channels facilitate delivering the electrolyte between and around the deposited particles and thereby can increase wetting (or electrolyte penetration) of the entirety of the electrode (e.g., from the top of the electrode to within the width of the electrode, and to the top of the substrate deposition surface). Channels can be formed along both the vertical and planar directions relative to the substrate. In some aspects of the disclosure, an average channel width can range from 50 nm to 50 μm, such as from 50 nm to 40 μm, or from 50 nm to 30 μm. The channels obtained using a single-particle layer configuration according to the present disclosure provide low tortuosity and thus less electrolyte blockage than electrodes that do not have a single-particle layer according to the present disclosure. In particular aspects of the disclosure, the single-particle layer-containing electrode disclosed herein exhibits better channel connectivity along the planar direction (or along the deposition surface of the substrate), thereby increasing electrolyte transport along the planar direction (or along the deposition surface of the substrate). In particular aspects of the disclosure using a sulfur-based electroactive material, tortuosity values (t) below 2 can be obtained, such as values ranging from 1 to 1.2, such as 1.16. In yet additional aspects of the disclosure, more channels can be obtained using a single-particle layer-containing electrode configuration according to the present disclosure than can be obtained using conventional electrodes, such as those using a plurality of small particles (e.g., particles with average diameters less than 40 μm, such as 20 m) wherein the small particles are randomly dispersed on a deposition surface of a substrate and form an MPL.

Electrodes comprising a single-particle layer according to the present disclosure exhibit low average porosities. In particular aspects of the disclosure, single-particle layer-containing electrodes of the present disclosure can exhibit average porosity values of less than 70%, such as less than 65%, or less than 55%, or even 45% or lower. These porosity values can be obtained for electrodes before and/or after calendaring. Even at low porosity values (e.g., 55% or lower), the single-particle layer-containing electrodes are able to exhibit good polarization and reduced capacity decay, particularly when compared to electrodes comprising MPLs comprising randomly dispersed particles. The single-particle layer-containing electrodes of the present disclosure can deliver constant large discharge capacity with high reproducibility at various porosity levels, even at levels of 45%.

### Methods

Disclosed herein is a method for making electrodes comprising a single-particle layer, as well as a method for using such electrodes.

The method for making the electrode comprises casting a slurry of secondary particles as described herein onto a deposition surface of a substrate such that a plurality of secondary particles is distributed horizontally along the deposition surface and only one secondary particle is deposited vertically along the deposition surface. In particular aspects of the disclosure, the thickness of the slurry is controlled during deposition to be no greater than 200% of the average particle size of the secondary particles. In some aspects of the disclosure, the method further comprises making the secondary particles by mixing precursor particles comprising a precursor particle material with a binder, a conductive material, a separate electroactive material (that is, an additional electroactive material from any electroactive material contained within the precursor particles used to make the secondary particles), or any combination thereof before depositing the slurry. In some aspects of the disclosure, the method further comprises drying the electrode, calendaring the electrode, or a combination thereof. In particular aspects of the disclosure, the slurry is deposited using a tape-casting technique.

The single-particle layer electrode can be used as an anode or cathode in a cell or other energy storage device. In some particular aspects of the disclosure, the single-particle layer electrode is used as a cathode in a cell. In particular aspects of the disclosure, the single-particle layer electrode comprises secondary particles that comprise a combination of a sulfur electroactive material and carbon-based primary particles and the electrode is used as a cathode. Cells comprising a single-particle layer-containing electrode according to the present disclosure can comprise (i) a single-particle layer-containing electrode as a first electrode, (i) a second electrode, and (iii) an electrolyte. Such cells exhibit improved performance relative to a cell lacking a single-particle layer-containing electrode. For example, such cells can exhibit a constant large discharge capacity, decreased deterioration, and electroactive material utilization. In some aspects of the disclosure, the cell can be in the form of a voltaic cell, an electrolytic cell, a fuel cell, or the like. In some aspects of the disclosure, the single-particle layer-containing electrode is used in any such cells to generate a voltage or current from a chemical reaction (or the reverse in which a chemical reaction is induced by a current). Batteries comprising a single-particle layer electrode according to the present disclosure also are contemplated.

### Overview of Several Examples

Disclosed herein is an electrode according to aspects of the present disclosure, comprising: a substrate having a deposition surface; and a single layer of secondary particles deposited on the deposition surface of the substrate such that each secondary particle of the single layer is positioned horizontally along the deposition surface and no more than one secondary particle is deposited vertically along the deposition surface; wherein each secondary particle of the single layer has an average particle size of at least 40 μm and comprises an electroactive material comprising sulfur.

In any or all of the above aspects, each secondary particle has an average particle size ranging from 40 μm to 100 μm.

In any or all of the above aspects, each secondary particle has an average particle size of at least 90 μm.

In any or all of the above aspects, the secondary particles comprise a conductive carbon material within the secondary particle.

In any or all of the above aspects, the electrode is a cathode.

In any or all of the above aspects, the single layer of secondary particles comprises a binder, a conductive carbon material, or a combination thereof, which can be physically and/or chemically coupled with the secondary particles.

In any or all of the above aspects, the single layer of secondary particles has a thickness that is no greater than 200% of the average particle size of each secondary particle.

In any or all of the above aspects, the single layer of secondary particles has channels between the secondary particles, and each channel has an average channel width ranging from 50 nm to 50 μm.

In any or all of the above aspects, wherein the single layer of secondary particles exhibits both low electrode tortuosity and low electrode porosity.

In any or all of the above aspects, the single layer of secondary particles exhibits low electrode tortuosity along both a vertical and horizontal direction of the single layer of secondary particles.

Also disclosed are additional examples of an electrode, comprising: a substrate having a deposition surface; and a single layer of secondary particles deposited on the deposition surface of the substrate such that each secondary particle of the single layer is positioned horizontally along the deposition surface and no more than one secondary particle is deposited vertically along the deposition surface; wherein each secondary particle of the single layer has an average particle size ranging from 0.1 nm to 500 μm and comprises an electroactive material other than sulfur.

In any or all of the above aspects, the electrode is an anode, and the electroactive material comprises graphite, silicon, silicon oxide, a metal, or a metal alloy.

In any or all of the above aspects, the electrode is a cathode, and the electroactive material comprises lithium cobalt oxide (LCO), lithium nickel cobalt aluminum oxide (NCA), lithium iron phosphate (LFP), lithium nickel manganese cobalt oxide (NMC), lithium nickel manganese cobalt oxide (LNMO), or lithium manganese oxide (LMO).

In any or all of the above aspects, the single layer of secondary particles comprises a binder, a conductive material, or a combination thereof, which can be physically and/or chemically coupled with the secondary particles.

In any or all of the above aspects, the single layer of secondary particles has a thickness that is no greater than 200% of the average particle size of each secondary particle.

In any or all of the above aspects, the single layer of secondary particles has channels between the secondary particles, and each channel has an average channel width ranging from 50 nm to 50 μm.

Also disclosed is a method of making the electrode according to any or all of the above aspects, comprising: casting a slurry of the secondary particles onto the deposition surface of the substrate while controlling a thickness of the slurry during casting to be no greater than 200% of the average particle size of each secondary particle and such that only one secondary particle is deposited vertically along the deposition surface.

In any or all of the above aspects, the method can further comprise: (i) mixing a binder, a conductive material, or a combination thereof with the secondary particles to form the slurry; (ii) drying the electrode; (iii) calendaring the electrode; or (iv) a combination of two or more of (i), (ii), and (iii).

Also disclosed is a cell, comprising: the single-layer electrode according to any or all of the above aspects; a second electrode; and an electrolyte.

### Examples

Synthesis of/KB/S material—The integrated Ketjen Black/Sulfur (IKB/S) composite used in examples described below was prepared according to the following representative procedure unless indicated otherwise: KB powder (AkzoNobel) and poly(melamine-co-formaldehyde) methylated solution (Sigma-Aldrich) were thoroughly blended with a weight ratio of 1:1 and then the mixture was dried and carbonized at 900° C. under Ar atmosphere for 10 hours. The collected IKB was heat treated with sulfur (weight ratio IKB:S=1:4) at 155° C. for 12 hours, resulting in IKB/S particles. The particles were then sieved and separated into different size ranges, including large particles (e.g., for examples discussed below, particles having average particle sizes greater that 90 m) and small particles (e.g., for examples discussed below, particles having average particle sizes less than 20 μm).

Electrode Preparation—Carbon nanofiber (Sigma-Aldrich) was first dispersed in a polyacrylic acid (Sigma-Aldrich) dimethylformamide (DMF) solution (2 wt %) to form a uniform slurry. Then, the IKB/S particles were added and thoroughly mixed in a Thinky mixer for 15 minutes (ARE-310, Thinky). The weight ratio of IKB/S, carbon nanofiber, and polyacrylic acid was controlled at 8:1:1, and the solid content in the slurry was 20%. The obtained slurry was cast onto aluminum foil with a sulfur loading of 4 mg cm⁻² and dried in a vacuum oven at 60° C. for 12 hours. The porosities of the electrodes were further controlled by manipulating electrode thickness by calendering and were cut into disks that had an area of 1.26 cm². The details of electrode porosity calculation are listed in Tables 1 and 2. Generally, for a 4 mg cm⁻² cathode with 64% sulfur content, the electrode porosity was estimated to be 72%, 63%, 52%, and 45% corresponding to an electrode thickness of 120, 90, 70, and 60 μm, respectively.

Characterization—The surface area of IKB was measured using nitrogen adsorption/desorption isotherms recorded by QUANTACHROME AUTOSORB 6-B gas sorption system. The calculation of surface area was based on the isotherms using the five points BET method. The morphologies of materials and electrode were observed using scanning electron microscopy (SEM, JEOL, JSM-IT800). For electrolyte distribution observation, the electrodes were assembled into coin cells with an E/S ratio of 4. After 3 hours at rest, the cells were disassembled, and the cathodes were taken out and dried under vacuum at 60° C.

For synchrotron XRD characterization, 14 cycled sulfur coin cells were disassembled inside an argon-filled glovebox. The cathode films were dried in glovebox overnight. In the glovebox, the 14 dried cathode discs were attached to the inner surface of a single large aluminum-lined pouch cell using a circle of Kapton tape slightly larger than the cathode diameter. The pouch was sealed under argon and was shipped to beamline 28-ID-2 of the National Synchrotron Light Source II (NSLS-II) at Brookhaven National Laboratory (BNL) for evaluation. At the beamline, the pouch cell was attached to the window of a stiff aluminum frame. Calibration was carried out using a CeO₂ powder (674b, NIST) sample in a Kapton capillary (1.1 mm in diameter) attached to the side of the frame. Diffraction data were collected using X-rays with a wavelength of 0.19316 Å on a Perkin Elmer amorphous silicon-based area detector (2048×2048 pixels with 200 μm square pixel edges) at a distance of about 1.6 μm using a 0.2 s subframe exposure time and a total acquisition time of 60 s per sample. Integration of the diffraction data was carried out over a 2q range of 0.5-15° (d=0.37-11.07 Å) with masks used to exclude the beam stop and the edges of the detector.

X-ray micro computed tomography (X-ray micro-CT) method was employed to obtain the three-dimensional (3D) microstructure of the sulfur electrodes. 3D-CT images of sulfur electrodes were reconstructed from a series of two-dimensional (2D) X-ray projection images obtained from a lab-based X-ray microscope (Zeiss, Versa 610). 2D images are measured at 20× (X-ray source energy and power: 65 kV, 6.5 W) and 40× (80 kV, 10 W) optical magnification in absorption-contrast mode. A total of 3202 2D projections were collected per 360° sample rotation with exposure times of 2 and 4 seconds for 20× and 40× optical magnifications, respectively.

Electrochemical Characterization—2032-type coin cells (MTI Corp.) were assembled in an Ar-filled glovebox. The electrode area was 1.26 cm². The thickness of the lithium anode was 250 μm. A Celgar-2400 separator with a 1.9 cm diameter was used in all coin cells. The electrolyte comprised 1 M lithium bis(trifluoromethanesulfonyl)imide (LiTFSI, Gotion), 1,3-dioxolane (DOL, Gotion) and 1,2-dimethoxyethane (DME, Gotion) (1:1, v/v), 0.3 M LiNO₃. The electrolyte to sulfur ratio was controlled as 10 μL/mg⁻¹ for the flooded electrolyte condition and 4 μL/mg⁻¹ for the lean-electrolyte condition. The coin cells were rested for 3 hours and then tested on a LANHE battery tester CT3001 Å at 0.1 C (1 C=1000 mA/g) at 30° C. in a voltage range of 1.8-2.8 V. The EIS study was performed on a Biologic SP-50 Potentiostat. The three-electrode-cell was assembled with the sulfur electrode and Li as working and counter electrodes, respectively, and a lithium titanate (Li₄Ti₅O₁₂, LTO) coated Cu wire was used as reference electrode and placed between the working and counter electrodes.

Simulation Method—Computational fluid dynamics (CFD) simulations were conducted to explain the species transport and wetting of the surface of micropores in the porous electrodes using a commercial CFD software STAR-CCM+. The simulations for the species transport were conducted to understand the transport of LiPS concentration in the electrode. Multiphase flow simulations using volume of fluid (VOF) explained the basic understanding of the electrolyte transport in a porous electrode comprising small or large particles.

Simulations for Electrolyte Wetting—The multiphase flow simulations using the VOF method were conducted first to understand the wetting of pore particles and electrolyte transport in the electrode. The governing equations were as follows:

$$∇ \cdot u = 0 , \qquad ( 1 )$$

$$\frac{\partial ( ρ u )}{\partial t} + ∇ \cdot ( ρ uu ) = - ∇ ρ + μ ∇ \cdot ( ∇ u + {( ∇ u )}^{T} ) + ρ g + F , \qquad ( 2 )$$

wherein, u is the velocity, ρ is the pressure, and g is the gravity. The terms ρ and μ are phase average density and viscosity, respectively, and were computed as:

$$\begin{matrix}ρ = {ρ}_{g} + α ( {ρ}_{l} - {ρ}_{g} ) \\ μ = {μ}_{g} + α ( {μ}_{l} - {μ}_{g} )\end{matrix} \} \qquad ( 3 )$$

wherein α is the volume fraction of the primary phase and I and g denote the liquid and gas phases, respectively. F is the surface tension force acting at the gas-liquid interface and is implemented by the continuous surface force model (CSF):

$$F = Γ \frac{ρκ ∇ α}{\frac{1}{2} ( {ρ}_{g} + {ρ}_{l} )} \qquad ( 4 )$$

wherein Γ is the interfacial tension value, κ is the local curvature of the interface, and ∇α is the gradient of the volume fraction representing the direction vector at the gas-liquid interface. The curvature κ is computed as the divergence of the unit normal (\hat{n}=∇α/|∇α|):

$$κ = ∇ \cdot \hat{n} \qquad ( 5 )$$

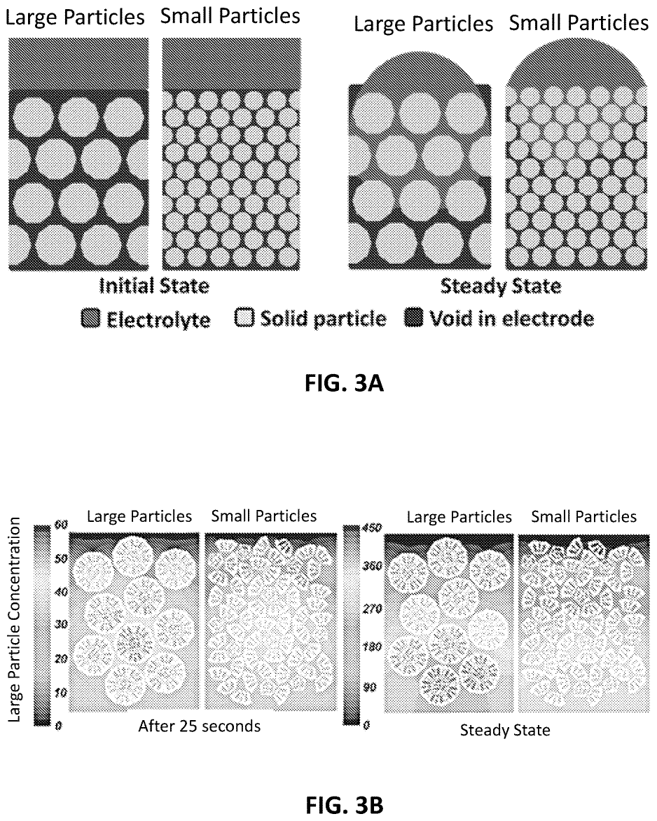

According to the experimental observations, two sizes (72 μm and 32 μm) of particle were chosen in the flow simulations. The model of the computational flow domain was created by a random arrangement of larger and smaller particles (see FIG. 3A). The electrolyte was poured into the flow domain through the top region above the electrode and flow was driven by the gravity. When adding electrolyte on the top of electrodes, gravity is the main driving force that initiates electrolyte infiltration. The flow is driven by gravity and the wetting is dictated by gravity, capillary force, and the surface characteristic of the solid substrate. In the pore-scale simulation, pressure drop is dictated by the pore-scale capillary pressure. In the simulation, the surface characteristics of the electrode were implemented by the contact angles at the surface of the particles, which is relative major of the adhesion and cohesion behavior. The wall of the particles was set as the no-slip wall with contact angle (γ). Both sides of the electrode were specified as the hydrophobic walls, whereas the wall of the pore particles was considered to be hydrophilic. The hydrophilic and hydrophobic conditions were defined by means of the value of the contact angle. The multiphase flow studies using the VOF method were conducted using air (ρₐ=1.185 kg/m³ and μₐ=0.0183 mPas), and electrolyte was used in the Li—S battery. The electrolyte comprised a mixture of 1,3-dioxolane (DOL) and 1,2-dimethoxyethane (DME) with 1 M LiTFSI. The electrolyte had physical properties of (μ_{/}32 2.56 mPas and ρ_{/}=997 kg/m³), surface tension (σ_{/}=34.4 mN/m), and contact angle (γ=20°). The implicit transient flow simulations were conducted with a very small timestep (Δt~10⁻⁷ sec) for stability and convergence because the grid size was on the order of 0.1 μm.

Scalar Transport Simulations—In addition to conducting multiphase flow simulations for the wetting of pore particles, flow simulations were conducted to understand the transport phenomenon due to diffusion of LiPS in the electrode. The diffusion of LiPS in an electrode was studied by solving the passive scalar transport equation, which is based on the standard convection-diffusion equation:

$$\frac{\partial C}{\partial t} + ∇ \cdot ( ρ uC ) = - ∇ \cdot ( D ∇ C ) \qquad ( 6 )$$

wherein, C is the concentration, which is treated as a passive scalar, and D is its diffusion coefficient. Dissolution of the LiPS in the electrode occurs mainly due to diffusion, and internal and external LiPS concentration gradients exist. The migration rate of the LiPS in the electrodes depends on the effective diffusion coefficient. In this regard, flow simulations for passive scalar transport were conducted to calculate the effective diffusivity in the electrodes. The passive scalar was representative of LiPS and the value of diffusion coefficient (D) of the scalar was kept constant for both electrodes. In contrast to solid pore particles used in two-phase flow studies, porous particles (see the porous zone inside the white region in FIG. 3B) were chosen in this case to understand the internal and external diffusion of LiPS in the electrode. The flow simulations were conducted by specifying the scalar flux rate at the internal pore surfaces of particles of the electrodes. The scalar flux specified at the internal pores deals the understanding the migration of LiPS in the electrodes. The top boundary of the flow domain was specified as a given value of the scalar concentration. Remaining boundaries of the flow domain were specified as zero flux. The unsteady flow simulations were performed and the scalar concentration at the internal pore surfaces was monitored. The simulations were continued until the scalar concentration at the internal pore wall achieved a steady-state value, and the results were further analyzed. Once the simulation achieved a steady state, the effective diffusivity (D_{eff}) was computed as D_{eff}=NΔy/S₀ΔC, where N is flux at the internal wall of porous particles, Δy is distance from the electrode surface, ΔC is concentration difference, and S₀ is the cross-sectional area.

### Example 1

In this example, impacts of reducing sulfur cathode porosity were studied using a sulfur electrode with a mass loading of ~4 mg cm⁻². In this example, different porosities were evaluated (~72% to ~45%) and were achieved by calendaring to decrease the electrode thickness from 120 to 60 μm (Table 1).

TABLE 1
Calculation results of electrode porosity and energy density at different porosities.

| Porosity | 72% | 63% | 52% | 45% |
|---|---|---|---|---|
| Thickness (μm) | 120 | 90 | 70 | 60 |
| Areal (cm²) | 1.26 | 1.26 | 1.26 | 1.26 |
| Electrode Volume (cm³) | 0.0151 | 0.0113 | 0.00882 | 0.00756 |
| Sulfur loading (mg/cm²) | 4 | 4 | 4 | 4 |
| Sulfur Volume (cm³) | 0.00241 | 0.00241 | 0.00241 | 0.00241 |
| NKB Volume (cm³) | 0.000694 | 0.000694 | 0.000694 | 0.000694 |
| CNF Volume (cm³) | 0.000434 | 0.000434 | 0.000434 | 0.000434 |
| PAA Volume (cm³) | 0.00063 | 0.00063 | 0.00063 | 0.00063 |
| Pore/electrolyte Volume (μl) | 10.9 | 7.16 | 4.64 | 3.38 |
| Electrolyte weight (mg) | 11.9 | 7.87 | 5.1 | 3.71 |
| Specific capacity (mAh g⁻¹) | 1000 | 1000 | 1000 | 1000 |
| Total Capacity (mAh) | 5.04 | 5.04 | 5.04 | 5.04 |
| Volumetric capacity (mAh cm⁻³) | 330 | 440 | 566 | 661 |
| Gravimetric Capacity (mAh g⁻¹) | 640 | 640 | 640 | 640 |
| Gravimetric Capacity With electrolyte (mAh g⁻¹) | 252 | 318 | 387 | 433 |

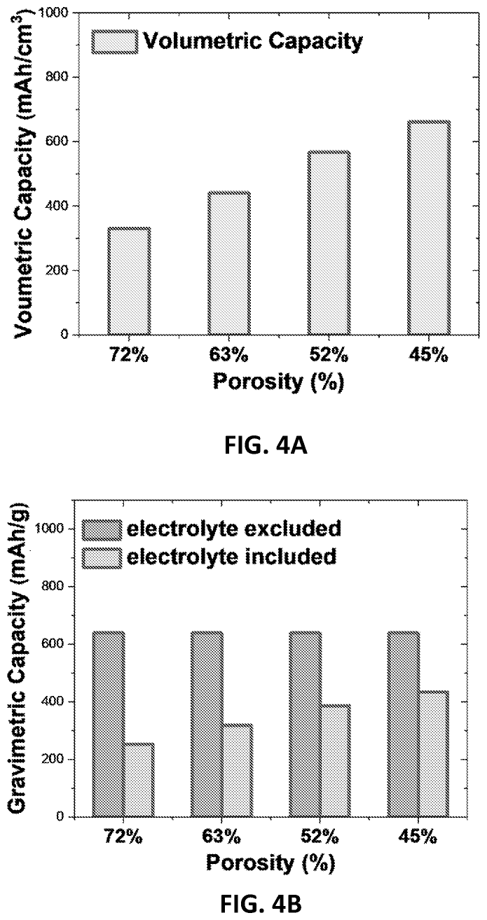

Sulfur cathodes reported in other studies typically have a very high porosity (>70%) due to the use of light and porous carbon hosts or additives. Given most of the pore volume of an Li—S cell is derived from the sulfur cathode when Li foil is used as the anode, decreasing cathode porosity can be beneficial in improving cell-level volumetric energy density. As shown in FIG. 4A, with a porosity of 72%, a thick electrode has a volumetric capacity as low as 330 mAh cm⁻³ (corresponding to an electrode-level energy density of ~693 Wh L⁻¹). If decreasing the porosity from 72% (120 μm) to 44.7% (60 μm), the corresponding volumetric capacity can be doubled to 661 mAh cm⁻³ (~1388 Wh L⁻¹). In addition, reducing electrode porosity also benefits gravimetric energy density since a denser electrode requires less pore-filling electrolyte, which does not contribute to the capacity but decreases electrode's practical energy density (FIG. 4B).

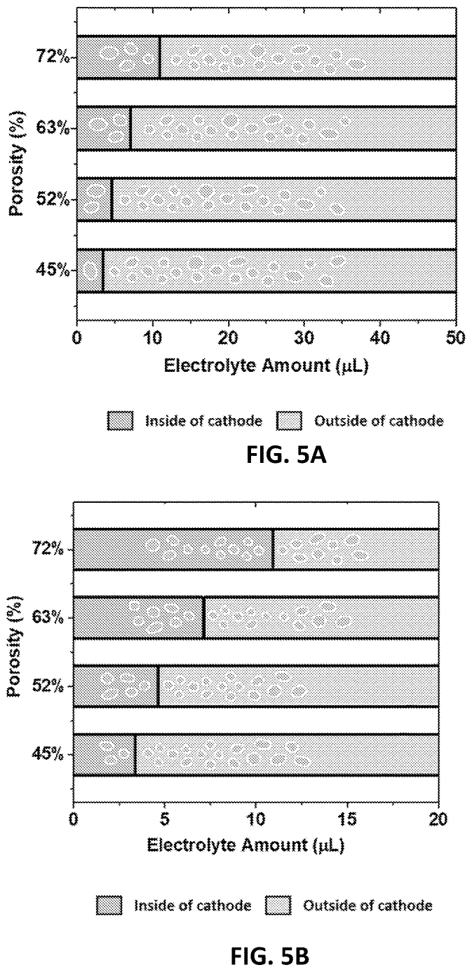

In practice, enabling operation of a dense electrode under practical conditions (e.g., sulfur loading≥4 mg cm⁻², E/S ratio 4 μL mg⁻¹) is quite challenging. Decreasing the electrode porosity will result in more serious LiPS outflow due to the elevated LIPS concentration gradient of the dense electrode. For example, under flooded electrolyte conditions (E/S=10 μL mgₛ⁻¹), the high-porosity electrode (72%) can hold up to 21.8 v % of total electrolyte, which decreases remarkably to only 6.8 v % in a 44.7%-porosity electrode (FIG. 5A, the detailed calculation can be found in Table 2). A consequence of such change is a higher LiPS concentration in the lower-porosity electrode. Driven by the elevated concentration gradient, more LiPS is prone to diffuse out of the electrode, exacerbating the shuttling effect. This phenomenon can be moderated by decreasing the electrolyte amount. For a 44.7%-porosity electrode, the electrolyte portion inside the electrode increases from 6.8 v % to 16.9 v % if the E/S ratio is decreased from 10 μL mgₛ⁻¹ to 4 μL mgₛ⁻¹ (FIG. 5B).

TABLE 2
Electrolyte volume distribution in Li—S cells under flooded
electrolyte condition and lean electrolyte condition.

| | | E/S 10 (total 50 μL) | E/S 4 (total 20 μL) |
|---|---|---|---|
| Porosity | Inside of Cathode | Outside of Cathode | Outside of Cathode |
| 72% | 10.9 | 39.1 | 9.1 |
| 63% | 7.16 | 42.8 | 12.8 |
| 52% | 4.64 | 45.3 | 15.3 |
| 45% | 3.38 | 46.6 | 16.6 |

### Example 2

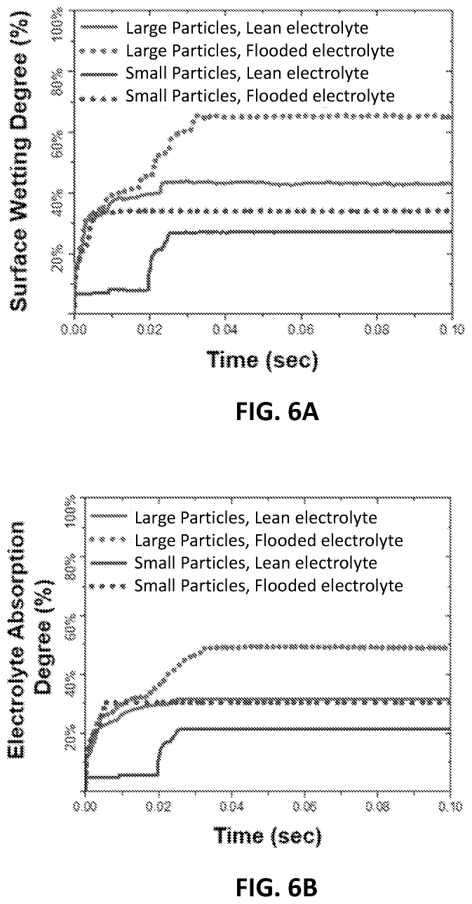

In this example, design principles of low-porosity sulfur cathodes were evaluated. In particular, both material structure and electrode architecture were considered in order to simultaneously enhance electrolyte accessibility while relieving LiPS shuttling and electrode blocking. As such, the effects of S/C materials on electrolyte wetting and LIPS diffusion were evaluated using computational fluid dynamics (CFD) simulations. Multiphase flow simulations using the volume of fluid (VOF) method were performed to investigate the electrolyte wetting process in porous electrodes at the same loading, thickness, and porosity but consisting of small (<20 μm) and large (>90 μm) particles. As shown in FIG. 3A, with the same electrode porosity and initial volume of electrolyte, a cathode comprising large particles shows better wettability, and the electrolyte can reach the deeper part of the electrode. In contrast, electrolyte hardly penetrates a cathode comprising small particles within the same time duration. FIGS. 6A and 6B plot the detailed calculations of the degree of surface wetting and electrolyte absorption in electrodes comprising small or large particles during electrolyte infiltration. Under lean-electrolyte conditions, the wetting degree of the electrode comprising small particles shows a plateau at the beginning, which means the electrolyte infiltration experiences significant repulsion due to the high capillary pressure developed in the small pores of the small particles, and only 20 v % of the electrode is filled with electrolyte. In contrast, for the large particles, both a quicker electrolyte infiltration and a higher wetting degree (31%) were observed. The multiphase flow simulation results suggest that an electrode structure composed of larger particles has quicker electrolyte infiltration and better wetting.

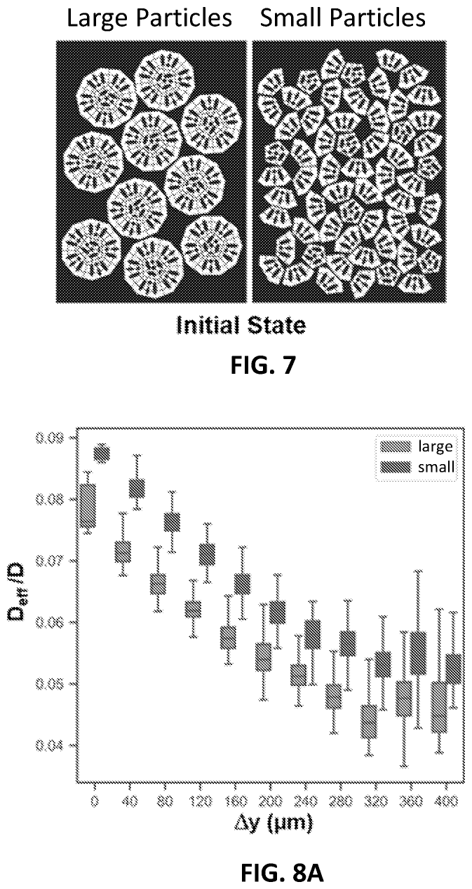

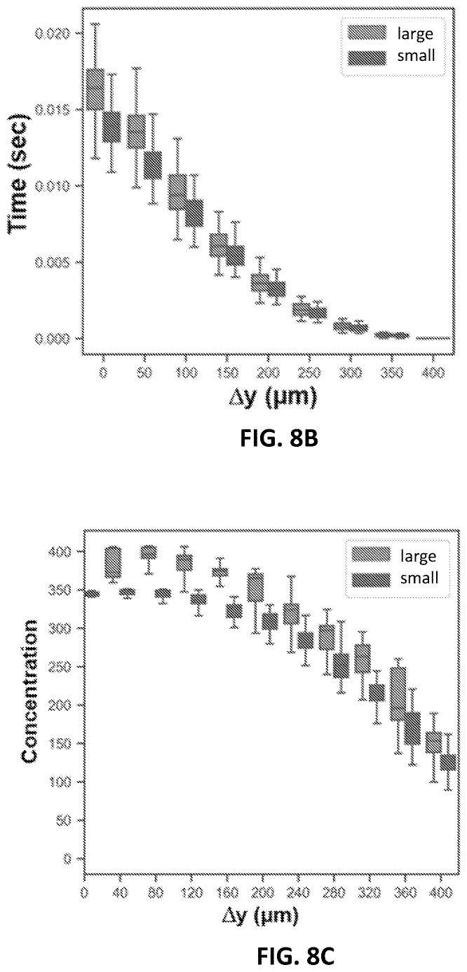

Further, a scalar transport simulation was performed to understand LiPS diffusion behaviors in electrodes comprising the small and large particles. The large particles did not necessarily lead to accelerated LiPS shuttling, but did exhibit better electrode wetting. As shown in FIG. 3B, the same basic structural units were integrated into secondary particles of different sizes, and the resulting electrodes had the identical overall porosities. The initial states of the electrodes are shown in FIG. 7 and both electrodes were fully wetted with electrolyte. Once the simulation started, the LIPS filled the pores inside the secondary particles. Driven by the concentration gradient, the LIPS will migrate outside the secondary particles in the electrode. FIG. 3B compares LIPS distribution in the electrodes under intermediate (25 seconds) and the steady-state conditions, respectively. For the large particles, a small proportion of LIPS diffuses out from large particles after 25 seconds, and a high polysulfide concentration still exists inside the particles. In contrast, within the same time period, small particles show an accelerated polysulfide outflow. Thus, after reaching steady state (the end of simulation, not the end of discharge), the polysulfide concentration in the large particles is higher than that in the small particles at each depth of electrodes (FIG. 3B), indicating suppressed polysulfide shuttling. The distinct polysulfide migration rate is due to the different effective diffusivities of LiPS in the large and small particles. Compared with larger particles, the effective diffusivity of LIPS in small particles is higher at each depth (FIG. 8A), so that less time is needed for LIPS diffusion out of the electrode (FIG. 8B), thereby resulting in a lower LiPS concentration inside (FIG. 8C). In contrast, a larger secondary particle has a longer diffusion pathway from the center to the outer surface. Eventually, LIPS in the electrode comprising the large particles has a higher chance to circulate inside the particles, suppressing LiPS shuttling and loss. As illustrated in FIG. 1, the secondary particles form electrolyte diffusion channels, which determine the electrolyte infiltration rate; and the inner surfaces of secondary particles form internal LIPS diffusion pathways, which dictate the LIPS diffusion rate. As suggested by the simulations, larger secondary particles are desired to enhance electrode wetting while reducing LIPS shuttling.

### Example 3

In this example, materials for a low-porosity sulfur cathode were evaluated.

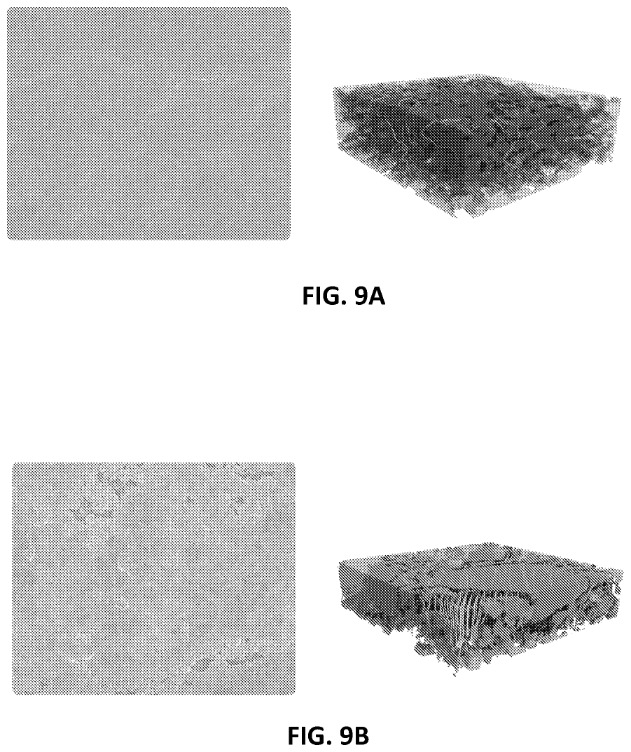

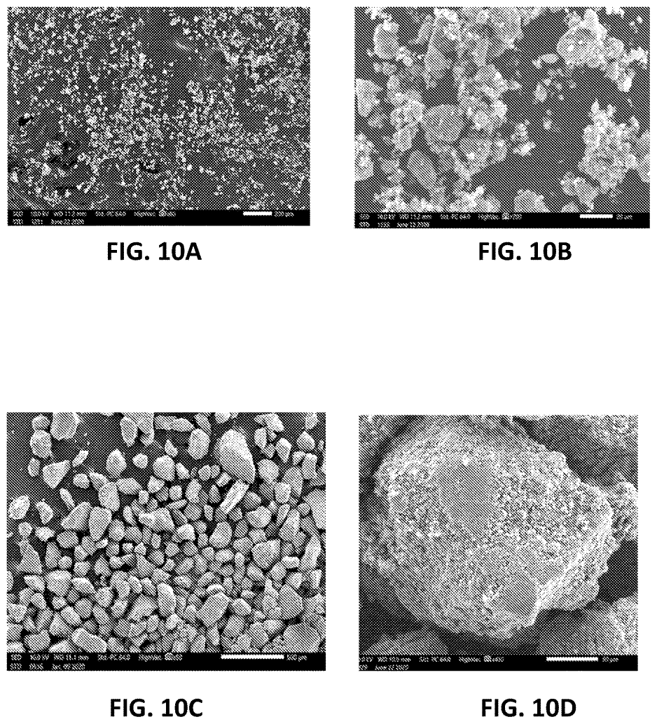

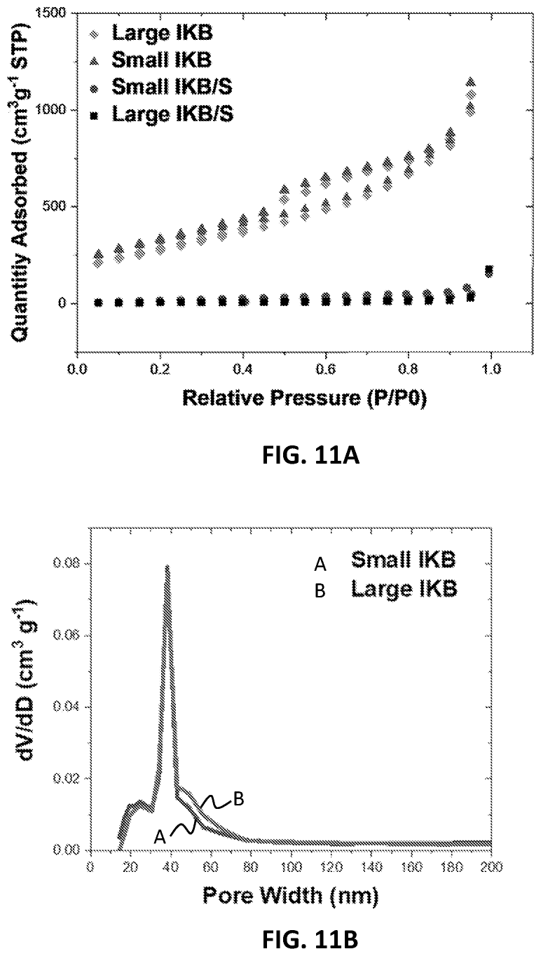

Nanosized and porous Ketjen Black (KB) particles were used as particle precursors and integrated into secondary particles (also referred to in this example as integrated KB or “IKB”) of different sizes by using the method described herein. The morphologies of the small (<20 μm) and large (>90 μm) secondary particles are exhibited in FIGS. 9A, 10A, and 10B (small secondary particles) and FIGS. 9B, 10C, and 10D (large secondary particles), and the measured Brunauer-Emmett-Teller (BET) surface areas are 1155 m² g⁻¹ and 1001 m² g⁻¹, respectively, before sulfur loading (FIGS. 11A and 11B). Although a lower surface area of larger particles, a similar pore volume is detected for large (3.86 cm³ g⁻¹, FIG. 11B) and small (3.88 cm³ g⁻¹) particles. After sulfur loading, the surface areas of large and small integrated Ketjen Black/sulfur (IKB/S) particles are reduced to 15 and 24 m² g⁻¹, respectively. The large particles have a tap density (0.714 g cm⁻³), which is twofold larger than that of the smaller ones (0.41 g cm⁻³).

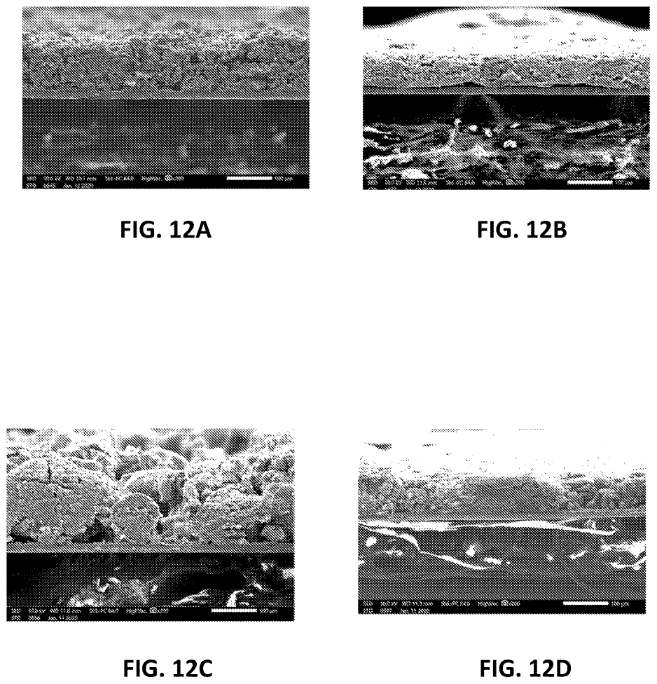

High-sulfur-loading electrodes (4 mg cm⁻²) were tape-casted using both types of particles (separately) to provide an MPL-containing electrode (using the small particles) and an SPL-containing electrode (using the large particles) and where then calendered to 60 μm thick (FIGS. 12A-12D). The calculated electrode porosity is around 44.7%, which is among the lowest porosities reported in the art. Scanning electron microscopy (SEM) characterization indicates that the MPL has a more compact and smoother surface (FIG. 9A); while in SPL-containing electrode, large channels are visible (FIG. 9B). To visualize the electrode structures, X-ray micro-computed tomography (X-ray micro-CT) was used to scan the MPL-containing electrode and SPL-containing electrode. Three phases (i.e., S/C particle, binder/carbon additive, and voids) are separated in FIGS. 2A and 2B. In the MPL-containing electrode, small particles tend to stack into a dense multiple-particle layer configuration during slurry coating and under calendaring. In addition, with the spread of the particles along the plane direction under pressure, horizontally aligned pores are formed (see FIG. 2A). As for the SPL-containing electrode, the cross-section micro-CT results indicate the SPL-containing electrode is composed of a single layer of particles (see FIG. 2B) with channels formed along both vertical and planar directions.

To quantify electrode tortuosity in the SPL-containing electrode and MPL-containing electrode, the acquired CT images are reconstructed into 3D models (see FIG. 9A, right-hand image for MPL-containing electrode; and FIG. 9B, right-hand image for SPL-containing electrode) and the electrolyte flow patterns are analyzed using CFD simulations to identify the complete channels from electrode surface to current collector. By extracting the streamlines from simulated electrolyte flow paths, electrode tortuosity can be defined as follows: τ=averaged streamline length/electrode thickness. As shown in FIG. 9A (right-hand image), the MPL-containing electrode has an estimated electrode tortuosity of 2.01 along the perpendicular direction. The high tortuosity suggests poor pore connectivity and a higher risk of electrolyte blockage in the MPL-containing electrode. In sharp contrast, the electrode tortuosity in the SPL-containing electrode (see FIG. 9B, right hand-image) can be as low as 1.16, which is close to the lowest value (τ=1) in a porous medium. This establishes that the large particles can form channels, which provides low-tortuous channels for electrolyte infiltration starting from electrode surface to the bottom. In addition, from the reconstructed 3D models, more electrolyte flow-through channels are observed in the SPL-containing electrode than in the MPL-containing electrode. Besides, the single-particle layer-containing electrode composed of large particles also has better pore connectivity along the planar direction, thereby benefiting electrolyte transport along the plane direction (that is, along the horizontal axis of the deposition surface).

### Example 4

In this example, electrochemical performance of a low-porosity sulfur cathode was evaluated.

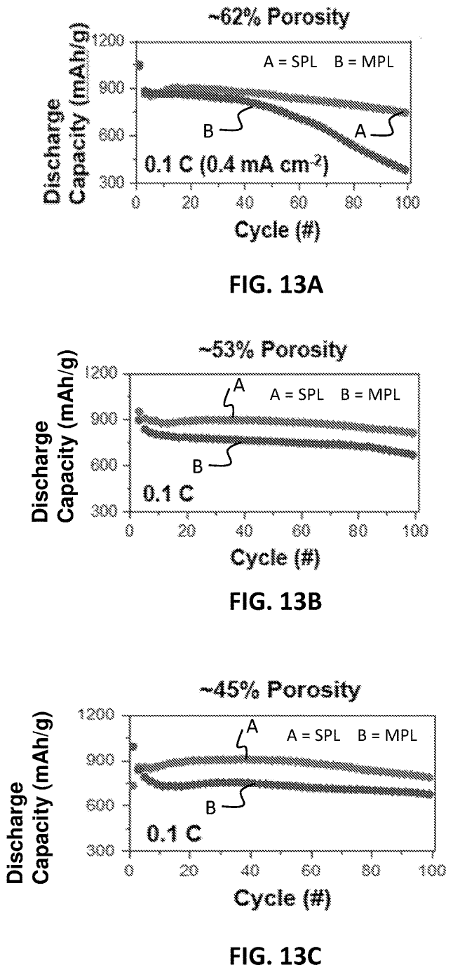

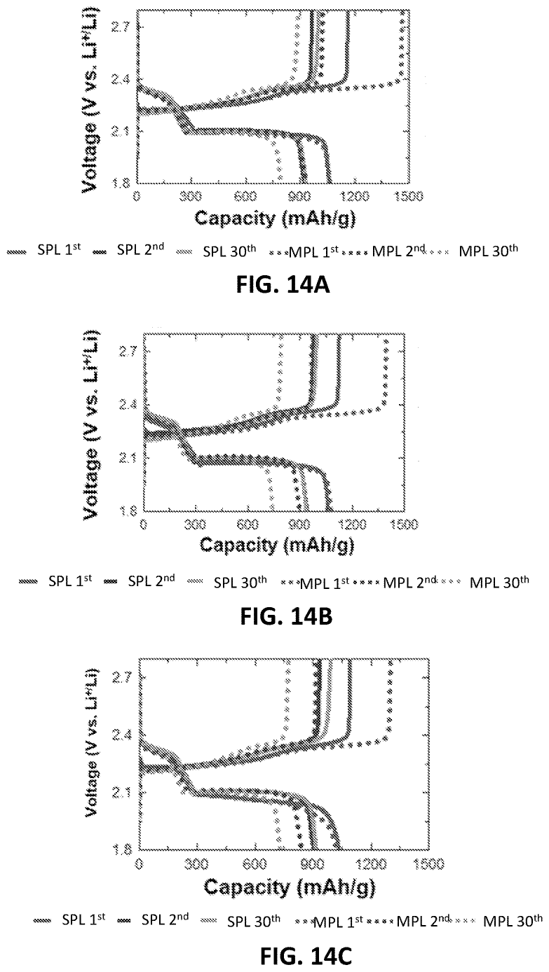

The effects of electrode architectures on sulfur reactions were first evaluated by testing the MPL-containing electrode and SPL-containing electrode at different porosities and electrolyte conditions. FIGS. 13A-13C compare the capacity retentions of the MPL-containing electrode and SPL-containing electrode for 100 cycles at 0.1 C under flooded electrolyte conditions (E/S=10 μL mgₛ⁻¹). At each level of porosity, the SPL-containing electrodes and MPL-containing electrode have very similar capacities for the first discharge. This is consistent with the flow simulation results that indicate flooded electrolyte conditions help relieve electrode wetting issues in dense electrodes. In subsequent cycles, the SPL-containing electrodes show much higher capacity and better capacity retention than the MPL-containing electrode. The SPL-containing electrode shows slightly improved cycling stability from when porosity is reduced from 62% to 53% and maintains similar performance even at an extremely low porosity of 45%. After 30 cycles, the SPL-containing electrodes with porosities of 62%, 53%, and 45% deliver reversible capacities of 932, 937, and 917 mAh g⁻¹, corresponding to capacity retentions of 87.9%, 88.1%, and 88.7%, respectively. For the SPL-containing electrode, most of the capacity loss occurs during the second discharge process, after which capacity stabilizes in the ensuing cycles (FIGS. 14A-14C). Apparently, at each porosity level, the 30th discharge curve is well overlapped with that of the 2nd cycle, showing a similar capacity and cell polarization. In contrast, performance degradation was observed in the MPL-containing electrode as the porosity decreased. After 30 cycles, the reversible capacities/capacity retentions of MPL-containing electrode at 62%, 53%, and 45% porosity were 793 (76.1%), 742 (68.8%), and 728 mAh g⁻¹ (71.1%), respectively.

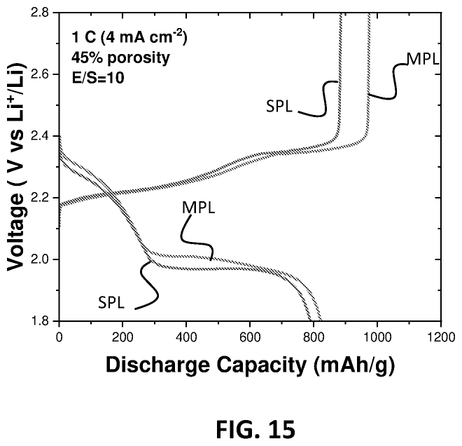

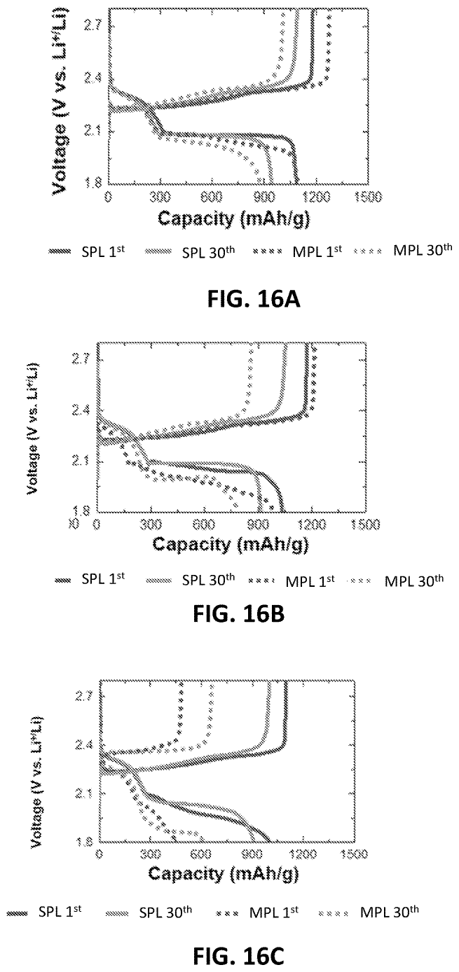

It was determined that particle size had a direct effect on the Coulombic Efficiency under flooded electrolyte conditions. As shown in FIGS. 14A-14C, at each porosity level, the SPL-containing electrode always has higher Coulombic Efficiency in both the first and subsequent cycles than the MPL-containing electrodes. After 100 cycles, the SPL-containing electrode at a low porosity of 45% delivers a capacity retention of ~85% at an E/S=10 μL mg⁻¹ (FIG. 13C). This can be explained by the increased particle dimension and inner surface area of the large secondary particles, which reduce shuttling and hence irreversible loss of LiPS. To understand the effects of particle size on the reaction kinetics, both MPL-containing electrode and SPL-containing electrode were evaluated at high C rate (1 C). As shown in FIG. 15, compared to MPL-containing electrode, the SPL-containing electrode shows a slightly increased polarization but a similar discharge capacity, which was observed only under flooded electrolyte conditions. If switched to lean electrolyte (E/S 4), poor electrolyte wetting of MPL-containing electrode starts to limit the reaction kinetics and lower the sulfur reactivity (FIGS. 16A-16C).

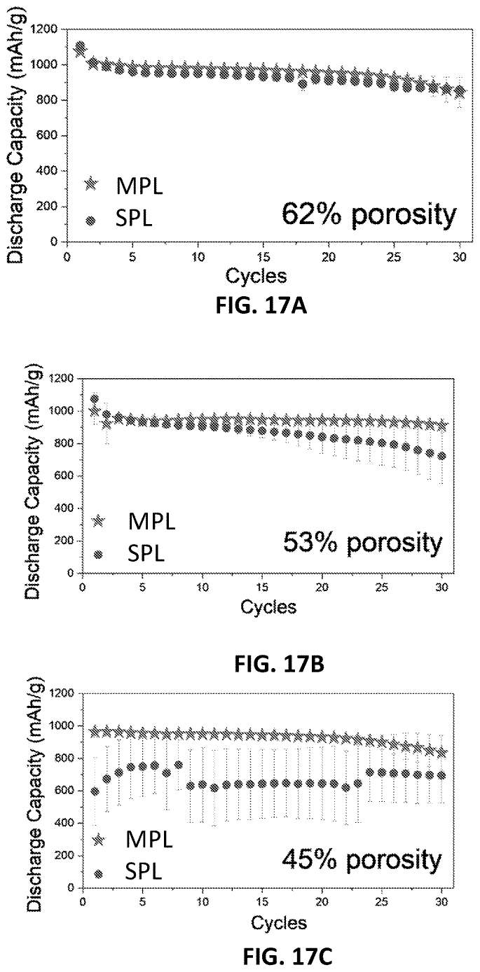

The SPL-containing electrode and MPL-containing electrode were further examined under lean-electrolyte conditions (E/S=4 μL mg⁻¹) where the electrolyte infiltration becomes more challenging, especially in a low-porosity cathode. At a relatively high porosity of 62%, the MPL-containing electrodes have almost identical reversible capacities and capacity retentions as those of the SPL-containing electrodes (FIG. 16A), although polarization is slightly higher in the MPL-containing electrodes. With a decrease of electrode porosity, more deteriorated polarization and capacity decay were observed in the MPL-containing electrode when porosity was decreased to 53%. At an extremely low porosity of 45%, the first discharge capacity dropped to only 451 mAh g⁻¹ (FIG. 16C). In contrast, the SPL-containing electrode at 45% porosity still delivered a high specific capacity of 1001 mAh g⁻¹. To avoid the bias among different cathodes, the data from six coin cells was included, with the error bar provided (FIGS. 17A-17C), showing that the SPL-containing electrodes deliver a constant large discharge capacity with high reproducibility at each porosity level, while capacity fluctuation was usually observed in the MPL-containing electrode, especially at 45% porosity. Such fluctuation indicates insufficient electrolyte wetting and varied wetting status in MPL-containing electrode.

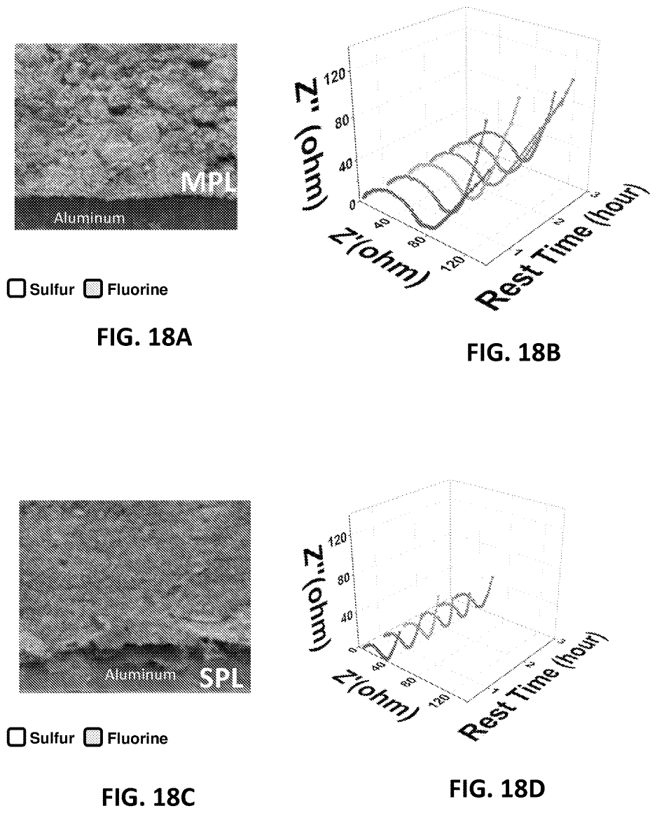

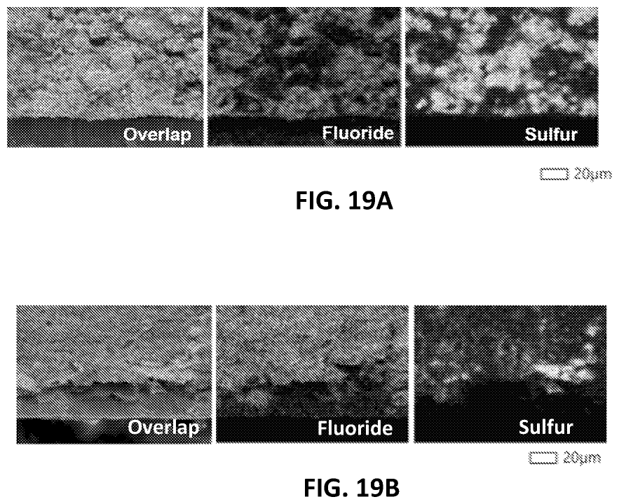

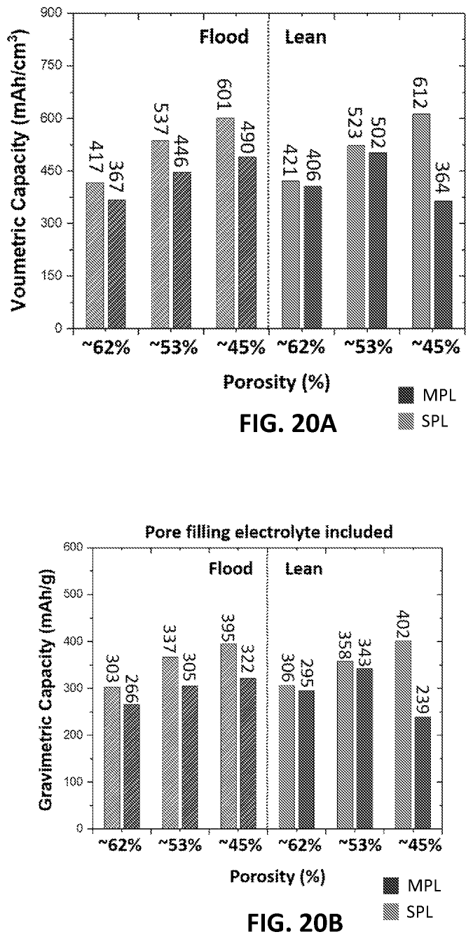

The electrolyte permeability in the MPL-containing electrode and SPL-containing dense electrodes were studied by tracking the lithium bis(trifluoromethanesulfonyl)imide (LiTFSI) distribution in energy dispersive spectroscopy (EDS) mapping, where fluorine from LiTFSI was used as the tracking reagent. As shown in FIGS. 18A, 18C, 19A, and 19B, the SPL-containing electrode exhibits a more uniform distribution of fluorine signal than the MPL-containing electrode. Given the same material chemistry and electrolyte, the EIS data before cell cycling can also be an indicator of electrode wetting. Compared to the MPL-containing electrode (FIG. 18B), the SPL-containing electrode (FIG. 18D) shows much smaller resistances for both bulk and overall charge-transfer (R_{ct}). This suggests a better wetting of the SPL-containing electrode. The difference in electrolyte infiltration in the MPL-containing electrode and SPL-containing electrode is not easy to demonstrate a significant impact on sulfur utilization at high porosity electrodes or flooded conditions, but it will determine the electrochemical performance in low-porosity electrodes and lean-electrolyte conditions as approved in FIG. 17A-17C. At least certain benefits of using the SPL-containing electrode were demonstrated by comparing the energy density of the MPL-containing electrode and SPL-containing electrode under different electrolyte conditions (FIGS. 20A and 20B). For MPL-containing electrode at flood electrolyte conditions, the volumetric and gravimetric capacities follow the same increasing trend with decrease of porosity. This means if electrolyte wetting is not an issue at flood electrolyte conditions, sulfur specific capacity increases with decreasing of porosity. However, at lean electrolyte conditions, the electrolyte wetting becomes worse with decrease of porosity, and sulfur specific capacity experiences a first increasing and then decreasing trend, especially at 45%. As a result, both volumetric and gravimetric capacity show a similar first increasing and then decreasing trend. While for SPL-containing electrode, similar increasing trend was observed for volumetric and gravimetric capacity at both flood and lean electrolyte conditions. From above comparison, the SPL-containing electrode is superior versus MPL-containing electrode at practical lean electrolyte and low porosity conditions.

### Example 5

In this example, the sulfur reaction process in a low-porosity sulfur cathode was evaluated.

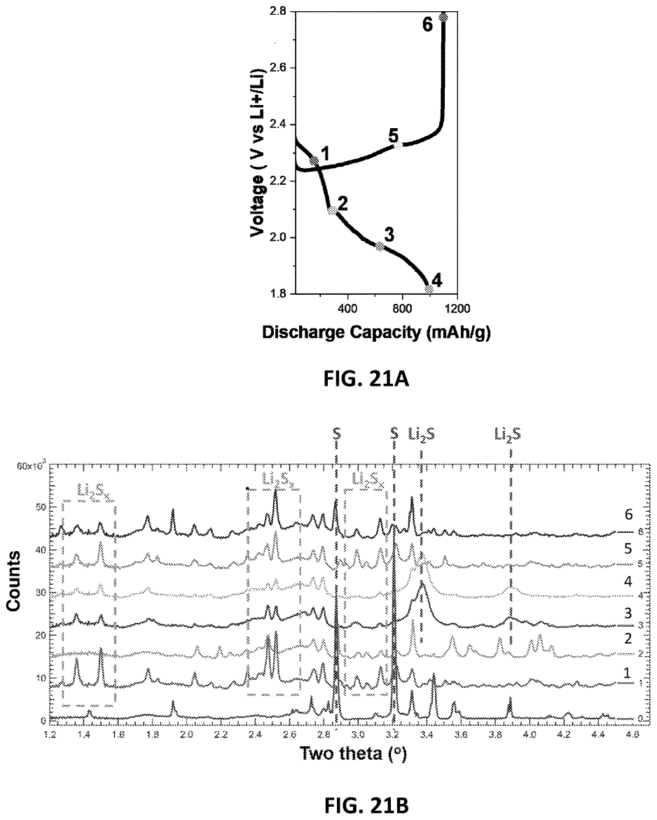

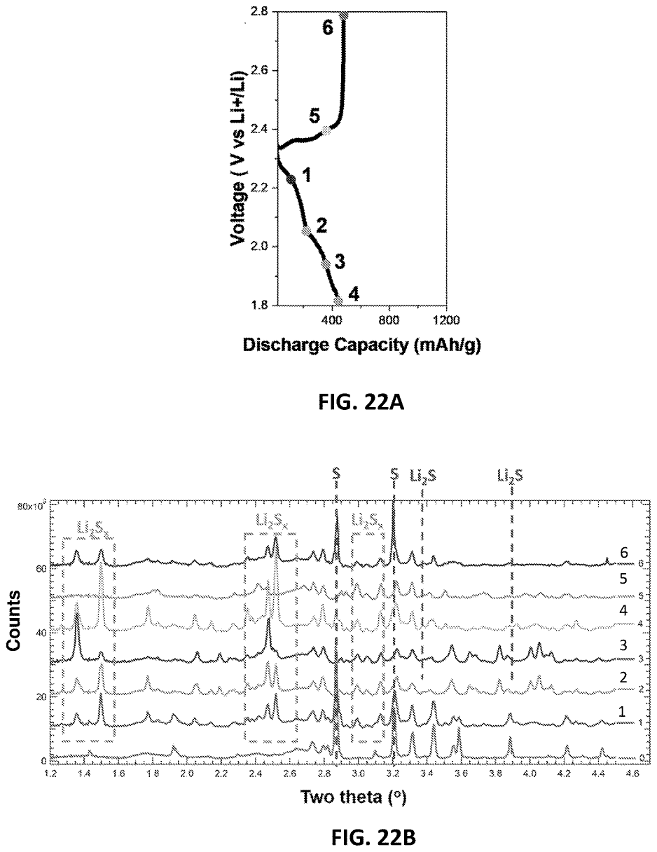

To understand the sulfur reactions in different dense MPL-containing electrodes and SPL-containing electrodes (porosity 45%) under lean-electrolyte conditions, a high-resolution synchrotron X-ray diffraction (XRD) study was performed. The cathodes were charged/discharged to designed voltages and collected for transmission ex situ XRD analysis. FIGS. 21A and 22A show the first discharge/charge profiles of the SPL-containing electrode and MPL-containing electrodes under lean-electrolyte conditions (E/S=4 μL mg⁻¹), respectively. The dense SPL-containing electrode delivers a high initial discharge capacity of ~1000 mAh g⁻¹ with two distinct discharge plateaus, while the dense MPL-containing electrode shows significantly suppressed discharge plateaus with an overall capacity of only 451 mAh g⁻¹. The MPL-containing electrodes and SPL-containing electrodes were harvested and dried directly for XRD analysis without further washing. Thanks to the high brightness of hard X-ray, the difference in the phase evolutions of S, LiPS, and Li₂S were clearly identified for the MPL-containing electrode (FIG. 22B) and SPL-containing electrode (FIG. 21B), wherein the phases are indicated with numbers 1-6 in FIGS. 21A, 21B, 22A, and 22B. Since SPL-containing electrode and MPL-containing electrode have the same electrode composition and are tested under the same conditions, any difference of the observed diffraction peaks would be ascribed to the different sulfur reaction extents and diffusion behaviors of the generated LiPS. For simplicity, the comparison is focused on the main phases of elemental S₈, LiPS, and Li₂S by tracking their respective characteristic diffraction peaks: 2.86°, 3.2° for S₈; 1.2-2.6°, 2.4-2.6° and 2.95-3.15° for LiPS; and 3.38° and 3.89° for Li₂S.

Both the pristine SPL-containing electrode and MPL-containing electrode have an α-S8 phase but in an amorphous or nanocrystalline state, as supported by the broad and low-intensity diffraction peaks at 2.86 and 3.2° (FIG. 21B and FIG. 22B, respectively, noted with dashed lines labeled “S”). For the SPL-containing electrode, once the discharge process starts (cutoff at 2.2 V), the α-S8 peaks become very weak, indicating fast reaction kinetics. Accompanying this, a new set of diffraction peaks was observed in the 2-theta ranges of 2.4-2.6° and 2.95-3.15° (labeled with dashed square boxes labeled with “Li₂Sₓ”), suggesting conversions of S₈ to LiPS. The densities of the new peaks decrease in subsequent discharging (cutoff: 2.1 V), indicating continuous reactions of LiPS. The XRD peaks observed in 1.2-1.6° were ascribed to the generated Li-polysulfides (Li₂Sₓ), which is a mixture of soluble Li₂Sₓ with different chain lengths and relative ratio. Concentration of Li₂Sₓ and ratio of each species are dependent on the depth of discharge and sulfur reactivity. With proceeding of cell reaction, total amount of Li₂Sₓ, relative ratio, and their distribution inside the electrode evolve, resulting in the irregular changes of XRD peaks. In the voltage range of 2.1 to 1.9 V, with the decrease in LiPS diffraction intensity, a new set of peaks grows at 3.38° and 3.89° (FIGS. 21B and 22B, noted with dashed lines labeled “Li₂S”), corresponding to cubic-phase Li₂S. The low and broad diffractions suggest the formed Li₂S is amorphous or nanosized at the end of discharge. During the subsequent charging process, the Li₂S peaks become weak and eventually disappear at 2.3 V, and the LIPS peaks reappear again, corresponding to the conversion of Li₂S to LiPS. At end of charging (cutoff: 2.8 V), low-intensity diffraction peaks of S₈ were observed, while in the MPL-containing electrodes, distinct behaviors were identified for each voltage range. In contrast to the quick disappearance of S in the MPL-containing electrode, the S₈ phase still maintains at a high content after discharging to 2.2 V and coexists with the LIPS phase until 2.1 V. This suggests sluggish kinetics of the S-to-LiPS reaction. Different to the fast and complete phase transformation of LIPS to Li₂S in the SPL-containing electrode, the LiPS phase coexists during the whole discharging process (FIG. 22B), and only very weak diffractions of Li₂S were found at the end of discharge (FIG. 22B). These observations suggest that transformation of LiPS to Li₂S is suppressed in the MPL-containing electrode. One explanation for this would be that the large proportion of LIPS diffuses out of the MPL-containing electrodes and even the electrode after generation, which is consistent with the poorer observed cell performance, i.e., low overall capacity and a short second discharge plateau (FIG. 22A).

Electrochemical and ex situ XRD results indicate that distinct S reaction processes in the MPL-containing electrode and SPL-containing electrode originate from the second discharge plateau, i.e., LiPS-to-Li₂S reactions. From the XRD results, for both cases, one can see that the soluble LiPS is generated during discharge but follows different pathways in the subsequent processes. Compared to the SPL-containing electrode, the MPL-containing electrode has much slower S-to-LiPS conversion kinetics, which may be caused by restricted electrode wetting. In addition, the LiPS diffuses out more quickly in the MPL-containing electrode and accumulates outside the electrode. During the next step, the LiPS-to-Li₂S conversion, only part of the LIPS can re-access the active particle surface and from Li₂S (or Li₂S₂) passivation layers, blocking the inflow of LiPS. A consequence of the blocked LIPS inflow would be the speed-up of sulfur irreversible loss (FIG. 22A), which would explain the very weak Li₂S diffractions in the MPL-containing electrode at the end of discharge (FIG. 22B). In the SPL-containing electrode, longer diffusion time is needed for the LiPS to flow out of the SPL-containing electrode. This reduces the LiPS loss and improves the conversion rate to Li₂S, as proved by XRD (FIG. 21B). Moreover, instead of forming a surface blocking layer, the SPL-containing electrode has larger and open pores to allow for the inflow of LiPS, which is also helpful for attaining high specific capacity.

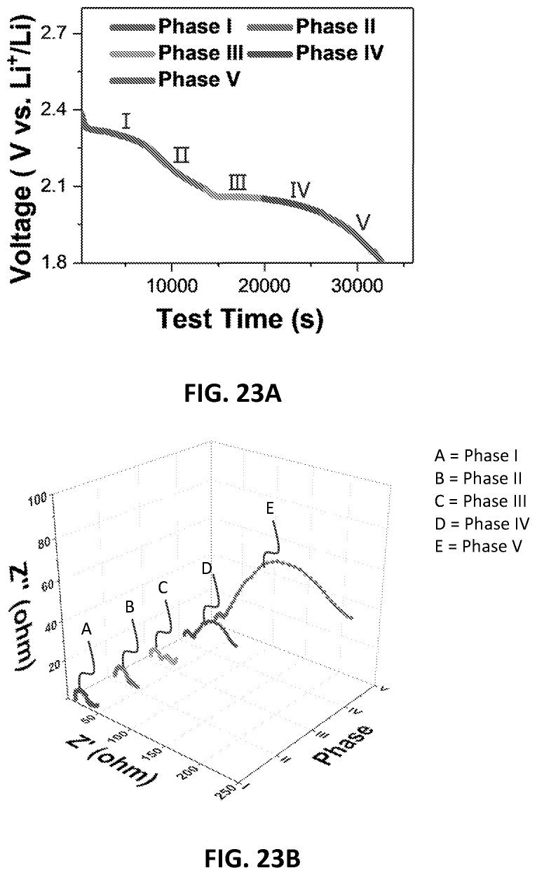

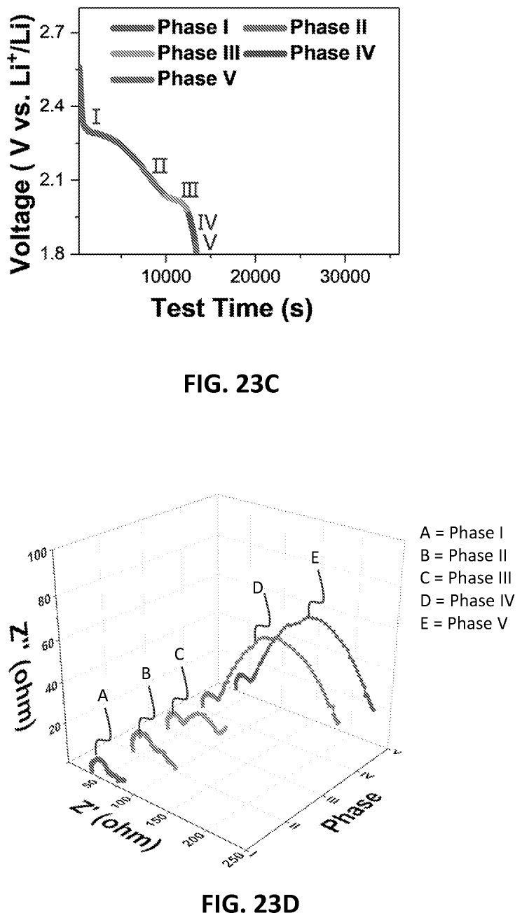

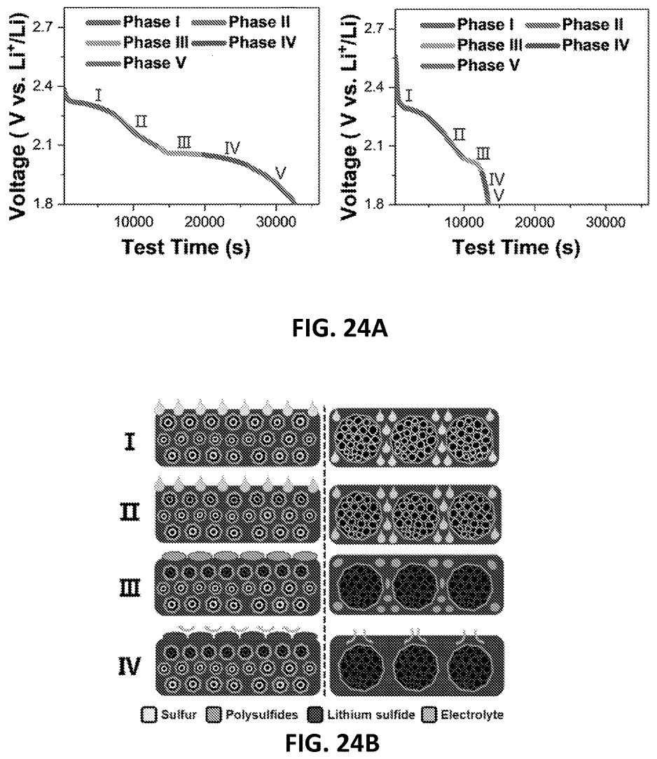

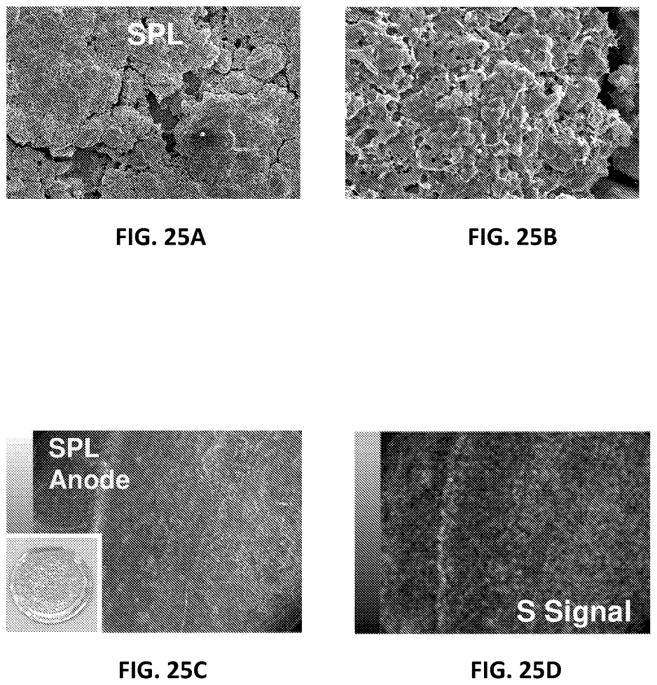

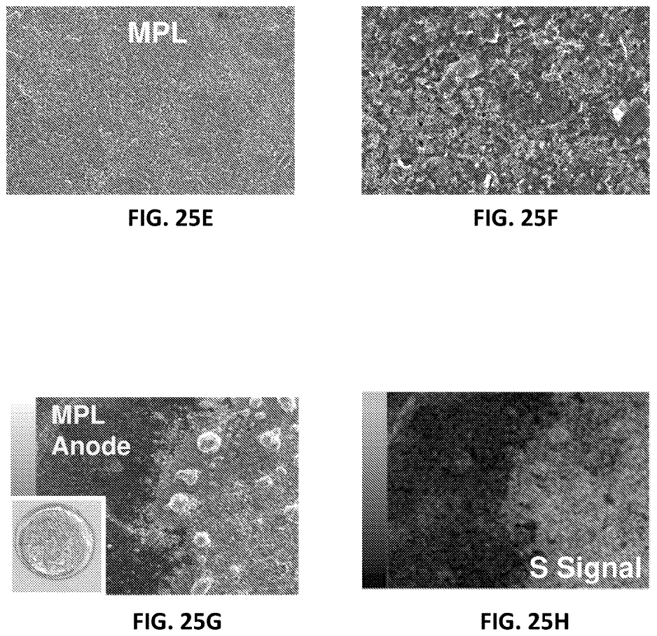

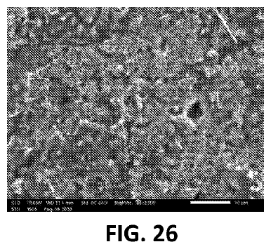

The sulfur reactions in the dense MPL-containing electrode and SPL-containing electrode were further studied by in situ EIS and electrode morphology characterization. To decouple the interferences of Li metal while acquiring EIS spectra, a three-electrode cell configuration was used, where a tiny strip of LTO (Li₄Ti₅O₁₂) reference electrode was wrapped with a polypropylene separator and placed between the S working electrode and Li metal counter electrode. FIGS. 23A and 23C plot the first discharge curves of the SPL-containing electrode and MPL-containing electrode under lean-electrolyte conditions (E/S=4 μL mg⁻¹) during EIS analysis. EIS results (FIGS. 23B and 23D) were acquired during cell discharging at intervals of 7000 seconds. Upon discharging, the overall Rot of the SPL-containing electrode decreased slightly and remained stable from Phase I to Phase III. This is attributed to the combined contributions of polysulfide generation and enhanced wetting. An increase in Ret was observed during Phase IV and grew quickly at the end of Phase V due to the formation of solid Li₂S/Li₂S₂. However, in the MPL-containing electrode, the overall resistance increased very early starting from the end of Phase II and surged to a level as high as that of Phase V in the SPL-containing electrode. These EIS results are consistent with the cell performance and ex situ XRD, confirming that the MPL-containing electrode is blocked early and terminated. Accordingly, a mechanism illustration depicting the difference of reaction process between SPL-containing electrode and MPL-containing electrode is proposed in FIGS. 24A and 24B. This is supported by SEM/EDS characterization of the discharged cells. After the first discharge, compact and smooth coating layers composed of flower-like precipitations were observed on the MPL-containing electrode (FIGS. 25E and 25F and FIG. 26), while a cleaner surface and open pores were maintained on the SPL-containing electrode (FIGS. 25A and 25B). It has been reported that when encapsulated in the carbon matrix, the LIPS will form amorphous or nanosized Li₂S after discharge; otherwise, it tends to form flake-like Li₂S particles. When examining the Li anode, the Li metal in an SPL-containing electrode cell maintained a relatively smooth surface after the first discharge (FIGS. 25C and 25D), while more and larger particles of LiPS or Li₂S were observed on the Li anode of the MPL-containing electrode cell (FIGS. 25G and 25H), suggesting more serious LiPS outflow in the MPL-containing electrode.

In view of the many possible embodiments to which the principles of the present disclosure may be applied, it should be recognized that the illustrated embodiments are only preferred examples and should not be taken as limiting the scope of the present disclosure. Rather, the scope is defined by the following claims. We therefore claim as our invention all that comes within the scope and spirit of these claims.

1. An electrode, comprising:
a substrate having a deposition surface; and
a single layer of secondary particles deposited on the deposition surface of the substrate such that each secondary particle of the single layer is positioned horizontally along the deposition surface and no more than one secondary particle is deposited vertically along the deposition surface; wherein
each secondary particle of the single layer has an average particle size of at least 40 μm and comprises an electroactive material comprising sulfur.

2. The electrode of claim 1, wherein each secondary particle has an average particle size ranging from 40 μm to 100 μm.

3. The electrode of claim 1, wherein each secondary particle has an average particle size of at least 90 μm.

4. The electrode of claim 1, wherein the secondary particles comprise a conductive carbon material within the secondary particle.

5. The electrode of claim 1, wherein the electrode is a cathode.

6. The electrode of claim 1, wherein the single layer of secondary particles comprises a binder, a conductive carbon material, or a combination thereof, which can be physically and/or chemically coupled with the secondary particles.

7. The electrode of claim 1, wherein the single layer of secondary particles has a thickness that is no greater than 200% of the average particle size of each secondary particle.

8. The electrode of claim 1, wherein the single layer of secondary particles has channels between the secondary particles, and each channel has an average channel width ranging from 50 nm to 50 μm.

9. The electrode of claim 1, wherein the single layer of secondary particles exhibits both low electrode tortuosity and low electrode porosity.

10. The electrode of claim 1, wherein the single layer of secondary particles exhibits low electrode tortuosity along both a vertical and horizontal direction of the single layer of secondary particles.

11. An electrode, comprising:
a substrate having a deposition surface; and
a single layer of secondary particles deposited on the deposition surface of the substrate such that each secondary particle of the single layer is positioned horizontally along the deposition surface and no more than one secondary particle is deposited vertically along the deposition surface; wherein
each secondary particle of the single layer has an average particle size ranging from 0.1 nm to 500 μm and comprises an electroactive material other than sulfur.

12. The electrode of claim 11, wherein the electrode is an anode, and the electroactive material comprises graphite, silicon, silicon oxide, a metal, or a metal alloy.

13. The electrode of claim 11, wherein the electrode is a cathode, and the electroactive material comprises lithium cobalt oxide (LCO), lithium nickel cobalt aluminum oxide (NCA), lithium iron phosphate (LFP), lithium nickel manganese cobalt oxide (NMC), lithium nickel manganese cobalt oxide (LNMO), or lithium manganese oxide (LMO).

14. The electrode of claim 11, wherein the single layer of secondary particles comprises a binder, a conductive material, or a combination thereof, which can be physically and/or chemically coupled with the secondary particles.

15. The electrode of claim 11, wherein the single layer of secondary particles has a thickness that is no greater than 200% of the average particle size of each secondary particle.

16. The electrode of claim 11, wherein the single layer of secondary particles has channels between the secondary particles, and each channel has an average channel width ranging from 50 nm to 50 μm.

17. A method of making the electrode of claim 1, comprising:
casting a slurry of the secondary particles onto the deposition surface of the substrate while controlling a thickness of the slurry during casting to be no greater than 200% of the average particle size of each secondary particle and such that only one secondary particle is deposited vertically along the deposition surface.

18. The method of claim 17, further comprising:
(i) mixing a binder, a conductive material, or a combination thereof with the secondary particles to form the slurry;
(ii) drying the electrode;
(iii) calendaring the electrode; or
(iv) a combination of two or more of (i), (ii), and (iii).

19. A cell, comprising:
the single-layer electrode according to claim 1;
a second electrode; and
an electrolyte.

20. A cell, comprising:
the single-layer electrode according to claim 11;
a second electrode; and
an electrolyte.
